(19) United States
(12) Patent Application Publication
(10) Pub. No.: US 2025/0242597 A1
(43) Pub. Date: Jul. 31, 2025

(54) PRINTING APPARATUS AND CONTROL METHOD FOR PRINTING APPARATUS

(71) Applicant: SEIKO EPSON CORPORATION, Tokyo (JP)

(72) Inventor: Nobuaki KAMIYAMA, MATSUMOTO-SHI (JP)

(21) Appl. No.: 19/037,678

(22) Filed: Jan. 27, 2025

(30) Foreign Application Priority Data
Jan. 29, 2024 (JP) 2024-010982

(51) Int. Cl. B41J 2/17; B41J 2/165; B41J 29/00

(52) U.S. Cl. CPC B41J 2/1742; B41J 2/1652; B41J 29/00; B41J 2002/16573

(57) ABSTRACT

A printing apparatus includes a liquid ejection unit that ejects liquid to perform printing, a liquid accommodation unit, and a control unit. The liquid accommodation unit includes an accommodation member that accommodates a liquid ejected by the liquid ejection unit in flushing, a feeding unit, and a winding unit. When a start signal for a print job is received, the control unit acquires an available amount of accommodation member that can be used and a predicted usage amount of the accommodation member predicted to be used in the print job when the accommodation member is fed by a reference feed amount per unit. When the available amount is smaller than the predicted usage amount, the control unit performs an extension operation of executing the print job by changing the reference feed amount per unit to a feed amount per unit smaller than the reference feed amount.

The present application is based on, and claims priority from JP Application Serial Number 2024-010982, filed Jan. 29, 2024, the disclosure of which is hereby incorporated by reference herein in its entirety.

### BACKGROUND

### 1. Technical Field

The present disclosure relates to a printing apparatus including a liquid ejection unit that ejects liquids, and a control method for a printing apparatus.

### 2. Related Art

For example, JP-A-2009-247923 discloses a droplet ejection apparatus including an ejection head (an example of a liquid ejection unit) having a nozzle that ejects droplets onto a medium, and a flushing unit. The flushing unit is an apparatus for performing a flushing operation of ejecting droplets from the nozzle in advance before the droplets ejected from the nozzle land on an ejection target. The droplet ejection apparatus includes a flushing (empty ejection) function of ejecting droplets from the nozzles of the liquid ejection unit onto an ejection target other than the ejection target, such as a substrate, to discharge a thickened liquid in the nozzles.

The flushing unit includes a sheet member (an example of an accommodation member) made of fabric or the like that accommodates the droplets ejected from the nozzle of the ejection head during flushing. The flushing unit includes a supply reel (an example of a feeding unit) that supplies the sheet member to a position facing a nozzle surface of the ejection head, and a winding reel (an example of a winding unit) that winds the sheet member supplied from the supply reel. The sheet member can be moved (sent) from the supply reel to the winding reel by driving an actuator.

Even when the droplet ejection apparatus is a printing apparatus that performs printing on a medium by ejecting droplets of ink or the like onto a medium such as paper, flushing for ejecting, from the nozzles, a liquid such as thickened ink in the nozzles is performed. Therefore, the above-described flushing unit is also used in a printing apparatus.

However, with the flushing unit described in JP-A-2009-247923, when the entire sheet member has been moved from the supply reel to the winding reel during printing, the sheet member cannot be sent any further to the position facing the nozzle surface. In this case, there is a problem that printing is interrupted because flushing is not possible. A timing at which a determination is made that flushing is not possible is not limited to a state in which the entire sheet member has been moved from the supply reel to the winding reel, and also includes a time when a remaining amount of sheet member reaches a preset value (a value greater than zero (>0)) when flushing is not performed.

### SUMMARY

A printing apparatus solving the problem includes a liquid ejection unit configured to perform printing on a medium by ejecting a liquid, a liquid accommodation unit configured to accommodate the liquid ejected in flushing regardless of the printing by the liquid ejection unit, and a control unit, wherein the liquid accommodation unit includes an accommodation member configured to accommodate the liquid, a feeding unit having the accommodation member set therein, and a winding unit configured to wind up the accommodation member, and the control unit acquires an available amount of the accommodation member available for flushing and a predicted usage amount of the accommodation member predicted to be used in the flushing in the print job when the accommodation member is sent at a reference feed amount per unit when the control unit receives a start signal for a print job, and performs an extension operation of executing the print job by changing the reference feed amount per unit to a feed amount smaller than the reference feed amount per unit when the available amount is smaller than the predicted usage amount.

A control method for a printing apparatus solving the problem is a control method for a printing apparatus including a liquid ejection unit configured to perform printing on a medium by ejecting a liquid, and a liquid accommodation unit configured to accommodate the liquid ejected in flushing regardless of the printing by the liquid ejection unit, the liquid accommodation unit including an accommodation member configured to accommodate the liquid, a feeding unit having the accommodation member set therein, and a winding unit configured to wind up the accommodation member, the control method including: acquiring an available amount of the accommodation member used for flushing and a predicted usage amount of the accommodation member predicted to be used in the flushing in the print job when the accommodation member is sent at a reference feed amount per unit when a start signal for a print job is received, and performing an extension operation of executing the print job by changing the reference feed amount per unit to a feed amount smaller than the reference feed amount per unit when the available amount is smaller than the predicted usage amount.

### BRIEF DESCRIPTION OF THE DRAWINGS

FIG. 1 is a schematic front cross-sectional view showing a printing apparatus in a first embodiment.

FIG. 2 is a schematic front cross-sectional view showing a state in which a liquid ejection unit is at a discharge position facing a liquid accommodation unit.

FIG. 3 is a schematic front cross-sectional view showing an example of the liquid accommodation unit.

FIG. 4 is a block diagram illustrating an electrical configuration of a printing apparatus.

FIG. 5 is a schematic diagram illustrating an extension operation selection screen.

FIG. 6 is a schematic diagram illustrating an error screen.

FIG. 7 is a schematic diagram illustrating a notification screen.

FIG. 8 is a schematic diagram illustrating an error screen when an accommodation member has run out.

FIG. 9 is a flowchart showing a print preparation processing routine.

FIG. 10 is a flowchart showing a print preparation processing routine in a second embodiment.

FIG. 11 is a flowchart showing a print preparation processing routine in a third embodiment.

### DESCRIPTION OF EMBODIMENTS

### First Embodiment

Hereinafter, a first embodiment of a printing apparatus will be described with reference to the drawings. The printing apparatus is, for example, an ink jet-type printer configured to eject ink that is one example of a liquid to a medium such as a sheet or fabric to print an image of characters, a photo, or the like.

### Printing Apparatus

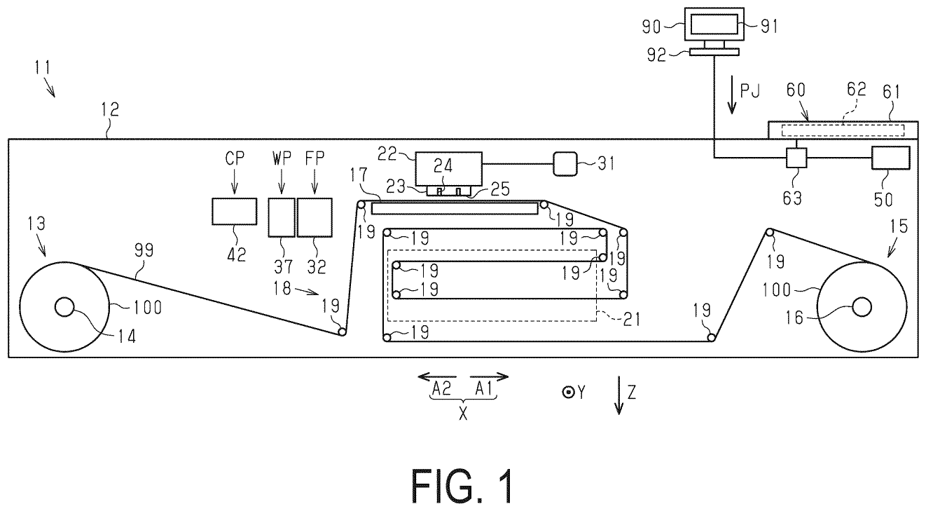

In the printing apparatus 11 illustrated in FIG. 1, three directions intersecting with each other (for example, orthogonal to each other) are indicated by an XYZ coordinate system, and are respectively referred to as an X direction, a Y direction, and a Z direction. The X direction and the Y direction intersect (for example, are orthogonal to) each other in, for example, a horizontal plane. The X direction is a scanning direction in which a liquid ejection unit 23 moves in the printing apparatus 11, and is therefore also called a scanning direction X. Further, the X direction is also a direction in which the medium 99 with a portion on which printing is performed by the liquid ejection unit 23 ejecting liquid is transported. The Y direction is a direction that intersects (for example, is orthogonal to) the scanning direction X on the horizontal plane. The Z direction is a direction parallel to a vertical direction, and is therefore also referred to as a vertical direction Z.

As illustrated in FIG. 1, the printing apparatus 11 includes a housing 12. The printing apparatus 11 includes a medium feeding unit 13. The medium feeding unit 13 is configured to feed the medium 99. The medium feeding unit 13 is accommodated in, for example, the housing 12. The medium feeding unit 13 includes a feeding shaft 14. The feeding shaft 14 rotatably holds a roll body 100 on which the medium 99 is wound. The feeding shaft 14 holds the medium 99 before printing. As the feeding shaft 14 rotates, the medium 99 is fed from the medium feeding unit 13. The feeding shaft 14 may be driven to rotate by a motor, or may be rotated in a driven manner by the medium 99 being pulled.

The printing apparatus 11 includes a medium winding unit 15. The medium winding unit 15 is configured to take up the medium 99. The medium winding unit 15 is accommodated, for example, in the housing 12. The medium winding unit 15 includes a winding shaft 16. The winding shaft 16 rotatably holds the roll body 100, similar to the feeding shaft 14. The winding shaft 16 holds the medium 99 after printing. As the winding shaft 16 rotates, the medium winding unit 15 winds the medium 99. The winding shaft 16 is driven to rotate, for example, by a motor.

The printing apparatus 11 includes a support portion 17. The support portion 17 supports the medium 99. The support portion 17 is accommodated, for example, in the housing 12. The support portion 17 supports the medium 99, for example, from below. The support portion 17 supports the medium 99 in a process from when the medium 99 is fed from the medium feeding unit 13 until when the medium 99 is taken up by the medium winding unit 15. Printing is performed on the area of the medium 99 supported by the support portion 17.

The printing apparatus 11 includes a transport unit 18. The transport unit 18 is configured to transport the medium 99. The transport unit 18 is accommodated in, for example, the housing 12. The transport unit 18 transports the medium 99 from the medium feeding unit 13 toward the medium winding unit 15. The transport unit 18 transports the medium 99 in, for example, a first direction A1 on the support portion 17. The transport unit 18 transports the medium 99 intermittently, for example. Specifically, the transport unit 18 stops while liquid is being ejected onto the area of the medium 99 supported by the support portion 17. The transport unit 18 transports the medium 99 after the liquid is ejected onto the area of the medium 99 supported by the support portion 17. The transport unit 18 is not limited to transporting the long medium 99 continuously from the roll body 100, and may transport the medium in single sheets.

The transport unit 18 includes one or more transport rollers 19. For example, the transport roller 19 is located in the housing 12, for example. The transport roller 19 rotates to transport the medium 99. The medium 99 is wound over the transport roller 19. The transport rollers 19 may sandwich the medium 99. The transport roller 19 rotates to transport the medium 99. The transport roller 19 includes, for example, a roller that is driven to rotate by a motor. A transport path of the medium 99 is formed in the housing 12 by the transport roller 19.

The printing apparatus 11 includes a drying unit 21. The drying unit 21 is configured to dry the medium 99 after printing. The drying unit 21 dries the medium 99 in a process in which the medium 99 is transported from the support portion 17 to the medium winding unit 15. The drying unit 21 is located, for example, inside the housing 12. The drying unit 21 is located, for example, directly below the support portion 17. The drying unit 21 may include a heater that heats the medium 99. The drying unit 21 may include a blower that blows a gas onto the medium 99.

The printing apparatus 11 includes a carriage 22. The carriage 22 is configured to move back and forth in the scanning direction X. The carriage 22 passes through a position facing the support portion 17 by moving back and forth in the scanning direction X. The carriage 22 is located, for example, above the support portion 17.

The scanning direction X includes the first direction A1 and the second direction A2. The second direction A2 is the opposite direction to the first direction A1. In the printing apparatus 11, a direction in which the carriage 22 moves matches a direction in which the medium 99 moves on the support portion 17. Therefore, the printing apparatus 11 is a lateral printer. In the case of the lateral printer, the carriage 22 may also be able to move in a sub-scanning direction Y. The printing apparatus 11 may be a serial printer in which the medium 99 is transported in a direction different from the scanning direction X. The printing apparatus 11 may also be a serial printer in which a direction different from the X direction that is a direction in which the medium 99 is transported is a scanning direction in which the carriage 22 moves.

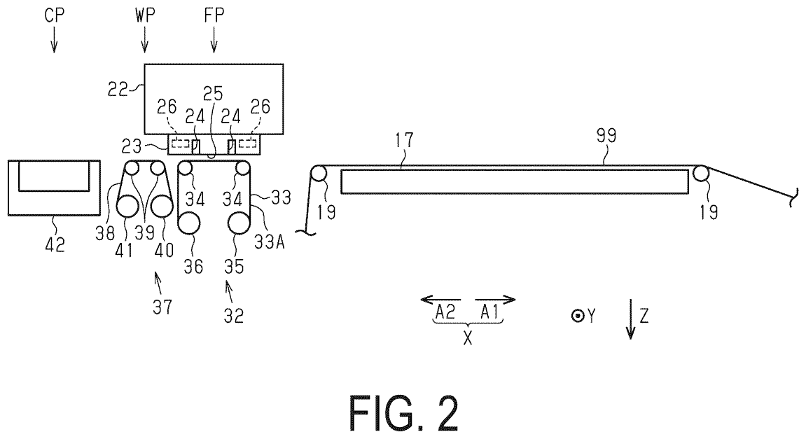

As illustrated in FIG. 2, the printing apparatus 11 includes the liquid ejection unit 23. The liquid ejection unit 23 is mounted on the carriage 22. The liquid ejection unit 23 is configured to eject liquid onto the medium 99. The liquid ejection unit 23 ejects the liquid onto the medium 99 to perform printing on the medium 99. The liquid ejection unit 23 includes a nozzle surface 25 in which one or more nozzles 24 are open. The liquid ejection unit 23 ejects the liquid from the nozzles 24.

The liquid ejection unit 23 includes one or more piezoelectric elements 26. The liquid ejection unit 23 includes the same number of piezoelectric elements 26 as the nozzles 24. The piezoelectric elements 26 change a pressure in the nozzles 24 when a voltage is applied. The piezoelectric elements 26 change the pressure in the nozzles 24, causing liquid to be ejected from the nozzles 24.

The piezoelectric elements 26 can change the pressure in the nozzles 24 so that liquid is not ejected from the nozzles 24. In other words, the piezoelectric elements 26 can vibrate the liquid in the nozzles 24 so that liquid is not ejected from the nozzles 24 by changing the pressure in the nozzles 24. Thus, the liquid ejection unit 23 can perform micro-vibration for vibrating the liquid in the nozzles 24. The liquid in the nozzle 24 is stirred by the micro-vibration. As a result, thickening of the liquid in the nozzle 24 is eliminated. The liquid ejection unit 23 performs micro-vibration appropriately, for example, before printing or during printing. The micro-vibration is performed in a state in which the liquid ejection unit 23 is stopped.

The liquid ejection unit 23 ejects the liquid onto the area of the medium 99 supported by the support portion 17. The liquid ejection unit 23 is, for example, a line head capable of ejecting liquid simultaneously across a width of the medium 99. The liquid ejection unit 23 moves back and forth in the scanning direction X together with the carriage 22. Accordingly, the liquid ejection unit 23 can eject the liquid over the entire area of the medium 99 supported by the support portion 17.

The liquid ejection unit 23 is displaced to a plurality of positions by moving in the scanning direction X. The liquid ejection unit 23 is not limited to the position facing the support portion 17, and can also be displaced to a position not facing the support portion 17. The liquid ejection unit 23 may move back and forth between the position facing the support portion 17 during printing, or may move back and forth to a position not facing the support portion 17 during an operation other than the printing.

As illustrated in FIG. 1, the printing apparatus 11 includes a pressurizing unit 31. The pressurizing unit 31 is configured to pressurize the inside of the liquid ejection unit 23. The pressurizing unit 31 is coupled to the liquid ejection unit 23. The pressurizing unit 31 is, for example, a pump. The pressurizing unit 31 supplies liquid to a flow path (not shown) communicating with the nozzle 24 by pressurizing. The liquid ejection unit 23 is coupled to a liquid supply source (not shown) such as an ink cartridge or ink tank through a flow path. The pressurizing unit 31 supplies, from the liquid supply source, an amount of liquid consumed by the liquid ejection unit 23 ejecting liquid from the nozzles 24, by pressurizing the flow path (not shown) communicating with the nozzle 24.

The flow path pressurized by the pressurizing unit 31 may be a circulation flow path passing through the inside of the liquid ejection unit 23. In this case, the pressurizing unit 31 may perform a circulation operation of circulating the liquid in the circulation flow path. The liquid such as ink contains a coloring matter. The coloring matter is, for example, pigment or dye. Depending on a type of liquid, the coloring matter (for example, pigment) may be prone to settling over time. When a liquid in which the coloring matter is prone to settling is used as described above, a circulation operation of circulating the liquid through the circulation flow path may be performed. The circulation operation stirs the coloring matter in the liquid, thereby curbing the settling of the coloring matter.

The printing apparatus 11 includes a liquid accommodation unit 32. The liquid accommodation unit 32 accommodates the liquid discharged from the nozzle 24 due to maintenance. When the liquid ejection unit 23 performs maintenance, the liquid accommodation unit 32 accommodates the liquid discharged from the nozzle 24.

The liquid ejection unit 23 is displaced to a flushing position FP. The flushing position FP is a position at which the liquid is discharged from the nozzle 24 by maintenance of the liquid ejection unit 23. By this maintenance, for example, air bubbles, foreign matter, or the like is discharged from the inside of the nozzle 24 along with the liquid. The flushing position FP is, for example, a position shifted in the second direction A2 from the position facing the support portion 17.

The printing apparatus 11 includes a wiping unit 37. The wiping unit 37 wipes the nozzle surface 25 by coming into contact with the nozzle surface 25. A liquid adhering to the nozzle surface 25 is removed by wiping the nozzle surface 25 with the wiping unit 37. In other words, the wiping unit 37 performs wiping on the liquid ejection unit 23. The wiping unit 37 wipes the nozzle surface 25 after cleaning, for example. When the cleaning operation is performed, the liquid adheres to the nozzle surface 25 as a result of the liquid being discharged from the nozzle 24. Thus, the wiping unit 37 may wipe the nozzle surface 25 after the cleaning operation. Accordingly, the liquid adhering to the nozzle surface 25 is removed.

The liquid ejection unit 23 is displaced to a removal position WP facing the wiping unit 37. The removal position WP is a position at which the liquid adhering to the nozzle surface 25 is removed. The removal position WP is a position at which the liquid ejection unit 23 is shifted in the second direction A2 from a position at which the liquid ejection unit 23 faces the support portion 17, for example.

The wiping unit 37 is aligned with the liquid accommodation unit 32 in the scanning direction X, for example. In one example, the wiping unit 37 is disposed at a position shifted in the second direction A2 from the liquid accommodation unit 32. When the liquid ejection unit 23 is located at the removal position WP, for example, the liquid ejection unit 23 faces the wiping unit 37. The wiping unit 37 comes into contact with the nozzle surface 25, for example, by approaching the liquid ejection unit 23 at the removal position WP. The wiping unit 37 may come into contact with the nozzle surface 25 by the liquid ejection unit 23 at the removal position WP approaching the wiping unit 37. The wiping unit 37 wipes the nozzle surface 25 by moving relative to the liquid ejection unit 23 in a direction along the nozzle surface 25 in a state in which the wiping unit 37 is in contact with the nozzle surface 25.

The printing apparatus 11 includes a contact portion 42. The contact portion 42 moisturizes the nozzle 24 by coming into contact with the nozzle surface 25. The contact portion 42 is, for example, a cap 42C. The contact portion 42 forms a space communicating with the nozzle 24 by coming into contact with the nozzle surface 25. That is, the contact portion 42 caps the liquid ejection unit 23. The nozzle 24 is moisturized by the capping. As a result, concern that clogging occurs in the nozzle 24 is reduced.

The liquid ejection unit 23 may wait at a retracted position CP facing the contact portion 42 until printing starts. The liquid ejection unit 23 is displaced to the retracted position CP facing the contact portion 42 at the time of this wait. The retracted position CP is a position at which the liquid ejection unit 23 stops when printing is not being performed, for example, when waiting for input of the start signal for the print job PJ is performed. The liquid ejection unit 23 waits at the retracted position CP when printing is not being performed. In other words, the retracted position CP is a home position of the liquid ejection unit 23. The retracted position CP is, for example, a position shifted in the second direction A2 from the position facing the support portion 17. When printing is started, for example, when the start signal for the print job PJ is input, the liquid ejection unit 23 is displaced from the retracted position CP toward the first direction A1 directed to a position of the support portion 17.

The liquid ejection unit 23 moves back and forth in the scanning direction X. The support portion 17 is disposed at a position shifted in the first direction A1 from the liquid accommodation unit 32, the wiping unit 37, and the contact portion 42. In the printing, the liquid ejection unit 23 moves in the first direction A1 from the retracted position CP. The liquid ejection unit 23 moves in the first direction A1 and the second direction A2 in a range of the position facing the support portion 17. For example, the liquid ejection unit 23 performs printing on a portion of the medium 99 supported by the support portion 17 by ejecting droplets of ink or the like from the nozzle 24 in a process of moving back and forth in a range facing the support portion 17.

The pressurizing unit 31 also forcibly discharges the liquid from the nozzle 24. In other words, the pressurizing unit 31 pressurizes the inside of the liquid ejection unit 23 to perform cleaning for forcibly discharging the liquid from the nozzle 24 of the liquid ejection unit 23. The cleaning is a maintenance for forcibly discharging the liquid from the nozzle 24 to discharge air bubbles, foreign matter, and the like from the nozzle 24 together with the liquid. Therefore, the pressurizing unit 31 causes the liquid ejection unit 23 to perform cleaning as maintenance.

As illustrated in FIG. 1, the printing apparatus 11 includes a control unit 50. The control unit 50 controls the printing apparatus 11. The control unit 50 controls, for example, the medium feeding unit 13, the medium winding unit 15, the transport unit 18, the drying unit 21, the carriage 22, the liquid ejection unit 23, the pressurizing unit 31, the liquid accommodation unit 32, the wiping unit 37, and the contact portion 42. The control unit 50 controls the feed amount per unit of the accommodation member 33 in the liquid accommodation unit 32, and the like.

The control unit 50 may control the pressurizing unit 31 executing a circulation operation of circulating the liquid in the circulation flow path passing through the liquid ejection unit 23 at predetermined time intervals. Through the circulation operation, a settling of coloring matter (for example, pigment) in the liquid is effectively prevented. The control unit 50 may execute the circulation operation after the printing has been completed. Accordingly, the next printing is executed smoothly. The control unit 50 may execute the circulation operation when the power of the printing apparatus 11 is switched from off to on. When the power is switched from off to on, the liquid has often remained stagnant for a long time. Therefore, the circulation operation can be used to stir the coloring matter that has settled in the liquid. The control unit 50 may change a length of time in which the circulation operation continues, or change a circulation strength.

As illustrated in FIG. 1, the printing apparatus 11 includes a display unit 61. The display unit 61 displays information. The display unit 61 is, for example, a liquid crystal display. The display unit 61 may display information notified of by the control unit 50. The display unit 61 may display information related to the circulation operation. The information related to the circulation operation is, for example, a time until the circulation operation ends. During the circulation operation, the display unit 61 may display, for example, a length of time required for the circulation operation, a time remaining until the circulation operation ends, and a time when the circulation operation ends.

As illustrated in FIG. 1, the printing apparatus 11 includes a selection unit 62. The selection unit 62 is configured to be operated by a user. The selection unit 62 is, for example, a touch panel. The selection unit 62 may be a button, a lever, a switch, or the like. The user operates the selection unit 62 to operate the printing apparatus 11. The user gives instructions to the printing apparatus 11, for example, by operating the selection unit 62. The printing apparatus 11 may also include an operation panel 60 including the display unit 61 and the selection unit 62.

As illustrated in FIG. 1, the printing apparatus 11 includes a reception unit 63. The reception unit 63 is configured to receive operations from the user. The reception unit 63 is coupled to the selection unit 62. The reception unit 63 is coupled to a host apparatus 90, which is an example of an external apparatus. The host apparatus 90 may be, for example, a personal computer. The reception unit 63 is, for example, a communication interface.

The reception unit 63 receives operations from the selection unit 62. The reception unit 63 receives operations from the host apparatus 90. Specifically, the reception unit 63 receives the print job PJ and a start signal therefor from the user. The control unit 50 executes the print job PJ based on the start signal received by the reception unit 63. A function of the host apparatus 90 may be included in the printing apparatus 11. In this case, a configuration may be such that the user can give the print job PJ and the start signal therefor to the reception unit 63 by operating the selection unit 62.

Configurations of Liquid Accommodation Unit 32, Wiping Unit 37, and Contact Portion 42

Next, the configurations of the liquid accommodation unit 32, the wiping unit 37, and the contact portion 42 will be described in detail with reference to FIG. 2.

The liquid accommodation unit 32 is an accommodation member 33. The accommodation member 33 is a member that absorbs liquid. The accommodation member 33 is, for example, a fabric. The accommodation member 33 accommodates the liquid discharged from the nozzle 24 and absorbs the liquid.

The liquid accommodation unit 32 accommodates, for example, the liquid discharged from the nozzle 24 by flushing. The flushing is a maintenance process in which liquid is ejected from the nozzle 24 to curb clogging of the nozzle 24. By flushing, for example, thickened liquid is discharged from the nozzle 24. The flushing is performed by applying a voltage to the piezoelectric element 26. The liquid accommodation unit 32 therefore accommodates the liquid discharged by flushing as maintenance. The amount of liquid discharged to the liquid accommodation unit 32 by flushing is smaller than the amount of liquid discharged to the liquid accommodation unit 32 by cleaning.

The liquid accommodation unit 32 is, for example, aligned with the support portion 17 in the scanning direction X. In one example, the liquid accommodation unit 32 is located in the second direction A2 relative to the support portion 17. The liquid accommodation unit 32 receives the liquid discharged from the liquid ejection unit 23 when the liquid ejection unit 23 is located at a position facing the liquid accommodation unit 32. Specifically, the liquid accommodation unit 32 receives the liquid discharged from the liquid ejection unit 23 when the liquid ejection unit 23 is located at the flushing position FP. The flushing position FP is a position at which the liquid ejection unit 23 faces the liquid accommodation unit 32.

The flushing may be performed in a state in which the liquid ejection unit 23 stops at the flushing position FP. The flushing may be performed in a state in which the liquid ejection unit 23 moves in the first direction A1 during printing. In other words, the flushing may be performed while the liquid ejection unit 23 passes through the flushing position FP during printing.

The liquid accommodation unit 32 includes, for example, a pair of holding rollers 34. The accommodation member 33 is wrapped around the pair of holding rollers 34. That is, the accommodation member 33 is suspended on the pair of holding rollers 34. Accordingly, the pair of holding rollers 34 hold the accommodation member 33. By the pair of holding rollers 34 holding the accommodation member 33, an area facing the nozzle surface 25 is formed in the accommodation member 33. The accommodation member 33 accommodates liquid in this area.

The liquid accommodation unit 32 including, for example, a feeding unit 35 and a winding unit 36. The feeding unit 35 supplies an unused accommodation member 33. The winding unit 36 collects the used accommodation member 33 by winding the used accommodation member 33 up. For example, the feeding unit 35 and the winding unit 36 rotate each time the accommodation member 33 accommodates a certain amount of liquid by flushing. In detail, the control unit 50 controls the liquid accommodation unit 32 so that the feed amount per unit of the accommodation member 33 is controlled. When flushing is required, the liquid ejection unit 23 moves to the flushing position FP and ejects the liquid from all the nozzles 24 toward the accommodation member 33.

During capping, the nozzles 24 communicate with a substantially closed space surrounded by the nozzle surface 25 and the cap 42C. During the capping, the liquid in the nozzles 24 is moistened by the vapor of the liquid remaining in the cap 42C. Therefore, during the capping, the thickening of the liquid in the nozzles 24 is curbed. During printing, the liquid ejection unit 23 is in an uncapped state, and therefore, the liquid in the nozzles 24 is exposed to the atmosphere. The liquid in the nozzles 24 thickens as a solvent evaporates or volatilizes. During printing, droplets are ejected from the nozzles 24 selected from among all the nozzles 24 based on image data. The liquid in the nozzles 24 is refreshed by the ejection of droplets. Meanwhile, the liquid in the non-ejecting nozzles 24 continues to thicken. Thus, the liquid in the non-ejecting nozzles 24 thickens over time during printing.

Therefore, the liquid in the non-ejecting nozzles 24 thickens depending on a magnitude of the printing time, the printing length of the medium, the printing amount, or the like during printing. Therefore, during printing, flushing is performed each time a flushing timing corresponding to the magnitude of the printing time, the printing length of the medium, the printing amount, or the like is reached. Flushing is also performed before and after printing. For example, when the flushing timing is managed by the printing time, the flushing is performed at the flushing timing each time a predetermined time (for example, 20 seconds) in a range of 5 seconds to 30 seconds, for example, has elapsed.

The wiping unit 37 includes a wiping member 38. The wiping member 38 is a member that comes into contact with the nozzle surface 25. The wiping member 38 is, for example, a fabric. The wiping member 38 absorbs the liquid adhering to the nozzle surface 25, thereby removing the liquid from the nozzle surface 25. The wiping unit 37 has, for example, one or more pressing rollers 39. The pressing roller 39 is a roller that presses the wiping member 38 against the nozzle surface 25. This allows the wiping member 38 to come into close contact with the nozzle surface 25. The wiping unit 37 includes, for example, a feeding unit 40 and a winding unit 41. The feeding unit 40 feeds an unused wiping member 38 before being used for wiping. The winding unit 41 collects the used wiping member 38 used for wiping by winding the used wiping member 38. For example, the feeding unit 40 and the winding unit 41 rotate each time the wiping member 38 wipes the nozzle surface 25 a predetermined number of times.

The contact portion 42 is, for example, aligned with the wiping unit 37 in the scanning direction X. In one example, the contact portion 42 is disposed at a position shifted in the second direction A2 from the wiping unit 37. The contact portion 42 faces the nozzle surface 25, for example, when the liquid ejection unit 23 is located at the retracted position CP. In this state, the contact portion 42 approaches the liquid ejection unit 23, causing the contact portion 42 to come into contact with the nozzle surface 25. The liquid ejection unit 23 may also approach the contact portion 42, causing the contact portion 42 to come into contact with the nozzle surface 25.

The contact portion 42 is, for example, a cap 42C that can come into contact with the nozzle surface 25. The cap 42C accommodates the liquid that is forcibly discharged from the nozzle 24 of the liquid ejection unit 23 by cleaning. The cap 42C comes into contact with the nozzle surface 25 to form a substantially closed space between the nozzle surface 25 and the cap 42C that communicates with the nozzle 24. In this capping state, the pressurizing unit 31 pressurizes the liquid ejection unit 23, causing the liquid to be forcibly discharged from the nozzle 24. The cap 42C is coupled to a waste liquid accommodation unit (not shown) through a discharge tube (not shown). By driving a suction pump (not shown) provided in the middle of the discharge tube, the waste liquid accommodated by the cap 42C is collected in the waste liquid accommodation unit through the discharge tube. Further, the cleaning may be suction cleaning that is performed by driving the suction pump under a capping state instead of the pressure cleaning using the pressurizing unit 31. In suction cleaning, the liquid ejected from the nozzle 24 during cleaning may be forcibly discharged by driving the suction pump to create a negative pressure in a substantially closed space surrounded by the nozzle surface 25 and the cap 42C.

Further, the liquid discharged from the nozzle 24 during cleaning may be accommodated by the liquid accommodation unit 32. In this case, the liquid ejection unit 23 is located at the flushing position FP during cleaning. In this state, the liquid ejection unit 23 is pressurized by the pressurizing unit 31, and the liquid is forcibly discharged from the nozzle 24. The accommodation member 33 may be fed at a predetermined feed amount each time cleaning is performed.

### Configuration of Liquid Accommodation Unit 32

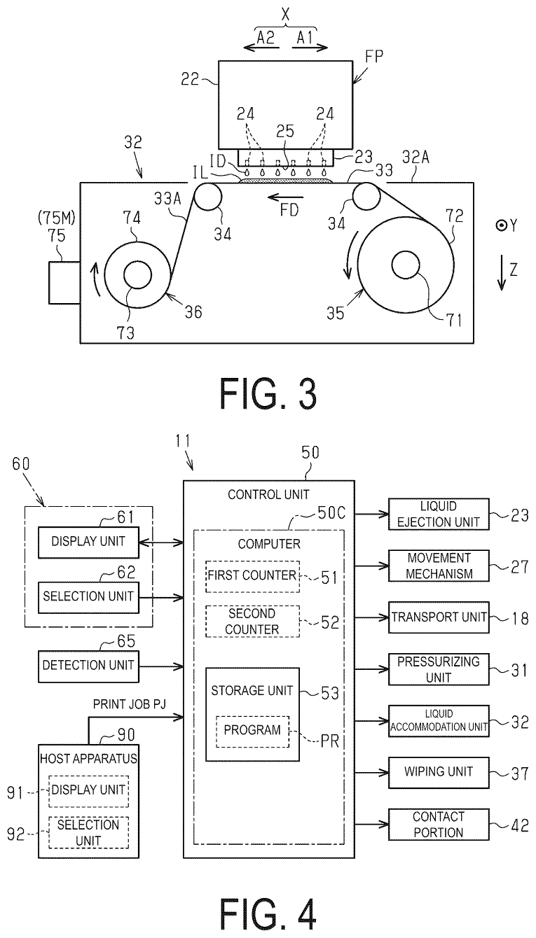

Next, a configuration of the liquid accommodation unit 32 will be described in detail with reference to FIG. 3.

As illustrated in FIG. 3, the liquid accommodation unit 32 may include an accommodation member 33, a feeding unit 35 in which the accommodation member 33 is set, and a winding unit 36 that winds the accommodation member 33 fed from the feeding unit 35. The accommodation member 33 accommodates liquid. In other words, an unused accommodation member 33 is set in the feeding unit 35. The feeding unit 35 feeds the set accommodation member 33. The winding unit 36 winds the accommodation member 33. In detail, the winding unit 36 winds the accommodation member 33 fed from the feeding unit 35. The accommodation member 33 accommodates the liquid ejected from the nozzle 24 of the liquid ejection unit 23 midway along a path on which the accommodation member 33 is fed from the feeding unit 35 and wound up by the winding unit 36.

The liquid accommodation unit 32 may have a pair of holding rollers 34. The pair of holding rollers 34 guide the accommodation member 33 along a feed direction FD parallel to the nozzle surface 25. The pair of holding rollers 34 are disposed upstream and downstream in the feed direction FD. The pair of holding rollers 34 are disposed at the same height in the vertical direction Z. The pair of holding rollers 34 guide the accommodation member 33 sent from the feeding unit 35 to the winding unit 36 in the feed direction FD along the feed path.

The feeding unit 35 and the winding unit 36 may be accommodated in a case 32A. The case 32A may have an opening that exposes the portion of the accommodation member 33 guided by the pair of holding rollers 34 to the liquid ejection unit 23.

The feeding unit 35 rotatably holds the unused accommodation member 33 wound in a roll. The feeding unit 35 unwinds and sends out the sheet-like accommodation member 33 by rotating in a direction indicated by an arrow illustrated in FIG. 3. The feeding unit 35 includes a feeding shaft 71. A first roll body 72 on which the unused accommodation member 33 is wound in a roll form is set on the feeding shaft 71. The feeding unit 35 includes the feeding shaft 71 and the first roll body 72 set on the feeding shaft 71.

The winding unit 36 includes a winding shaft 73. The used accommodation member 33 is wound on the winding shaft 73 as a roll-shaped second roll body 74. The accommodation member 33 is wound in a roll form by the rotation of the winding shaft 73. The winding unit 36 includes the winding shaft 73 and the second roll body 74 wound on the winding shaft 73.

The feeding shaft 71, the winding shaft 73, and the pair of holding rollers 34 are supported rotatably in a state in which respective rotation axes thereof are parallel to each other. In the example illustrated in FIG. 3, the rotation axes of the feeding shaft 71, the winding shaft 73, and the pair of holding rollers 34 are parallel to the Y direction. The pair of holding rollers 34 guide the accommodation member 33 wound around the holding rollers 34, thereby guiding the accommodation member 33 to a path parallel to the nozzle surface 25 of the liquid ejection unit 23. In other words, a part of the accommodation member 33 guided by the pair of holding rollers 34 is held in a state in which the part is parallel to the nozzle surface 25 of the liquid ejection unit 23 when this is at the flushing position FP.

Also, as illustrated in FIG. 3, the liquid accommodation unit 32 may include a drive unit 75 as an example of a drive source that feeds the accommodation member 33. The drive unit 75 may be configured to wind up the accommodation member 33 by rotating the winding unit 36 in a winding direction indicated by an arrow in FIG. 3, for example. In this case, the winding unit 36 may wind up the accommodation member 33, so that the unused accommodation member 33 is fed from the feeding unit 35. That is, the winding unit 36 may actively rotate, and the feeding unit 35 may be driven by the rotation of the winding unit 36.

The drive unit 75 may drive the feeding unit 35 instead of the winding unit 36. In this case, the drive unit 75 may rotate the feeding unit 35 to unwind the unused accommodation member 33 in the unwinding direction indicated by the arrow in FIG. 3. The drive unit 75 may be configured to rotate the feeding shaft 71 in the unwinding direction, for example, to wind the used accommodation member 33 as the second roll body 74 mounted on the feeding shaft 71.

Further, the drive unit 75 may drive both the feeding unit 35 and the winding unit 36. In this case, the feeding unit 35 and the winding unit 36 may be driven by the single common drive unit 75. The drive unit 75 may be, for example, a single common drive unit that drives both the feeding shaft 71 and the winding shaft 73. The feeding unit 35 and the winding unit 36 may be driven by a separate drive unit 75. For example, the drive unit 75 may be two drive units that drive the feeding shaft 71 and the winding shaft 73 individually.

The drive unit 75 drives and rotates the feeding shaft 71 and the winding shaft 73 in synchronization with each other. A drive force of the drive unit 75 can feed the accommodation member 33 in the feed direction FD from the feeding unit 35 to the winding unit 36. At least one of the pair of holding rollers 34 may be rotated by the drive force of the drive unit 75.

The drive unit 75 may be, for example, a motor 75M. The drive unit 75 may be an actuator other than the motor 75M. The drive unit 75 may be an actuator that can feed the accommodation member 33 in the feed direction FD.

The drive unit 75 may be controlled by the control unit 50. The drive unit 75 may be controlled by the control unit 50 so that the feed amount per unit of the accommodation member 33 is controlled.

When the liquid ejection unit 23 is located at the flushing position FP illustrated in FIG. 3, a gap between the nozzle surface 25 and the accommodation member 33 is set to a predetermined value. The gap may be set to a predetermined value in a range of 0.1 to 10 mm, for example.

When the liquid ejection unit 23 is located at the flushing position FP illustrated in FIG. 3 at which the liquid ejection unit 23 faces the accommodation member 33 across the gap, all the nozzles 24 eject droplets ID at once. The droplets ID ejected at once from all the nozzles 24 land on the accommodation member 33. The droplets ID that land on the accommodation member 33 adhere to the accommodation member 33 as a liquid IL. The liquid IL adhering to the accommodation member 33 is absorbed by the accommodation member 33 or deposited on the accommodation member 33. When the droplets ID ejected from the nozzles 24 are ink that dries easily, the liquid IL dries before the liquid IL is completely absorbed by the accommodation member 33, and therefore the dried liquid IL is easily deposited on the accommodation member 33. On the other hand, when the droplets ID ejected from the nozzles 24 of the liquid ejection unit 23 are inks that do not dry easily, the liquid IL adhering to the accommodation member 33 is easily absorbed by the accommodation member 33.

When the gap is too large, mist minute in size among the droplets ID ejected from the nozzles 24 is likely to scatter into the air without reaching the accommodation member 33. When a proportion of the droplets ID that scatter without landing on the accommodation member 33 increases, the scattered mist or the like may cause contamination inside the housing 12 of the printing apparatus 11. Therefore, the gap may be set to a value equal to or less than a predetermined upper limit value.

On the other hand, when the gap is too small, the droplets ID ejected from the nozzles 24 may land on the accommodation member 33, and then bounce around and adhere to the nozzle surface 25. The liquid adhering to the nozzle surface 25 may cause color mixing by mixing with the liquid in the nozzle 24, or may come into contact with the liquid ejected from the nozzle 24 during printing to cause a flight path of the droplet ID to change. Therefore, the gap may be set to a value equal to or greater than a predetermined lower limit value.

For this reason, the gap may be set to a predetermined value in a predetermined range. The gap may be set to an appropriate value according to a nozzle diameter, droplet size, ejection force, ink type, ink viscosity, or the like. Therefore, the gap may be a value outside a range of 0.1 to 10 mm.

The feed amount per unit of the accommodation member 33 by the control unit 50 may be set in consideration of the ease of drying of the liquid (for example, ink), the gap, or the like. When the liquid is one that dries easily, dried matter (including thickened matter, or the like) of the liquid IL is deposited on the accommodation member 33. The control unit 50 may send the accommodation member 33 at a timing at which this deposit does not come into contact with the nozzle surface 25 and a feed amount per unit that is a feed amount. Further, when the liquid is difficult to dry, the liquid remains in a liquid state even after being absorbed by the accommodation member 33. When an amount of absorbed liquid in an ejection target area of the accommodation member 33 exceeds a predetermined value, the absorbed liquid may leak from a lower surface (back surface) of the accommodation member 33 due to its own weight. Therefore, the control unit 50 may send the accommodation member 33 at a timing that the liquid does not leak from the lower surface of the accommodation member 33 and a feed amount per unit that is a feed amount.

During the flushing operation, the control unit 50 may detect the presence or absence and amount (remaining amount) of the accommodation member 33 in the feeding unit 35. That is, the control unit 50 may detect whether the first roll body 72 is mounted on the feeding shaft 71, or may detect the amount of the first roll body 72 mounted on the feeding shaft 71. The control unit 50 may detect the presence or absence of the accommodation member 33 and the amount of the accommodation member 33 by a detection unit 65 (see FIG. 4), such as a weight sensor or an optical sensor. When the accommodation member 33 is not present on the feeding shaft 71 and when the amount of the accommodation member 33 remaining on the feeding shaft 71 is small, the control unit 50 may notify the user of the fact. The control unit 50 may, for example, prompt the user to refill or replace the accommodation member 33 by displaying information for prompting the user to refill or replace the accommodation member 33 on the display unit 61.

### Electrical Configuration of Printing Apparatus 11

Next, an electrical configuration of the printing apparatus 11 will be described with reference to FIG. 4. The printing apparatus 11 receives, for example, the print job PJ from the host apparatus 90. The print job PJ includes image data and printing condition information. The host apparatus 90 includes a display unit 91 and a selection unit 92.

The control unit 50 is electrically coupled to the display unit 61 and the selection unit 62 that constitute the operation panel 60. The detection unit 65 is electrically coupled to the control unit 50. The detection unit 65 detects the presence or absence and amount of the accommodation member 33 in the feeding unit 35 of the liquid accommodation unit 32. The detection unit 65 may be, for example, a weight sensor or an optical sensor. For example, the weight sensor may be configured to detect a weight of the accommodation member 33 set in the feeding unit 35 and detect the amount of the accommodation member 33 based on the detected weight. Also, for example, the optical sensor may be configured to optically detect a distance to the accommodation member 33 set in the feeding unit 35 and detect the amount of the accommodation member 33 based on the detected distance. The detection unit 65 may use other known detection methods as long as the amount of the accommodation member 33 in the feeding unit 35 can be detected.

The liquid ejection unit 23, the movement mechanism 27, the transport unit 18, the pressurizing unit 31, the liquid accommodation unit 32, the wiping unit 37, and the contact portion 42 are also electrically coupled to the control unit 50. The control unit 50 controls the liquid ejection unit 23, the movement mechanism 27, the transport unit 18, the pressurizing unit 31, the liquid accommodation unit 32, the wiping unit 37, and the contact portion 42.

The control unit 50 also includes a computer 50C. The computer 50C includes a central processing unit (CPU), a read only memory (ROM), a random access memory (RAM), and a storage (not shown). The control unit 50 controls the transport of the medium 99 in the printing apparatus 11 or a printing operation on the medium 99 using the liquid ejection unit 23. In detail, the control unit 50 is not limited to performing software processing for all processes that the control unit 50 executes. For example, the control unit 50 may include a dedicated hardware circuit (for example, an application specific integrated circuit: ASIC) that performs hardware processing for at least some of the processes that the control unit 50 executes. That is, the control unit 50 may be configured as a circuitry including one or more processors that operate according to a computer program (software), one or more dedicated hardware circuits that execute at least some of various processes, or a combination thereof. The processor includes a CPU and a memory such as a RAM and a ROM, and stores program code or instructions configured to cause the CPU to execute a memory and processes. The memory, that is, a computer readable medium, includes any available medium accessible by the general-purpose or dedicated computer 50C.

The computer 50C includes a first counter 51, a second counter 52, and a storage unit 53. The first counter 51 counts a count value indicating a position of the carriage 22. The computer 50C resets the first counter 51 when the carriage 22 is at an origin position in the scanning direction X. The movement mechanism 27 that moves the carriage 22 includes a linear encoder (not shown) that can output a number of pulse signals proportional to an amount of movement of the carriage 22 in the scanning direction X. The computer 50C determines whether a movement direction of the carriage 22 is the first direction A1 or the second direction from a phase of the pulse signal from the linear encoder. The computer 50C increments the number of pulse edges of the pulse signal from the linear encoder when the movement direction of the carriage 22 is the first direction A1. On the other hand, the computer 50C decrements the number of pulse edges of the pulse signal from the linear encoder when the movement direction of the carriage 22 is the second direction A2. Thus, the control unit 50 acquires a current position of the carriage 22 in the scanning direction X based on the count value of the first counter 51. The second counter 52 counts a count value related to a feed amount of the accommodation member 33 of the liquid accommodation unit 32. A counting process of the second counter 52 will be described in detail later.

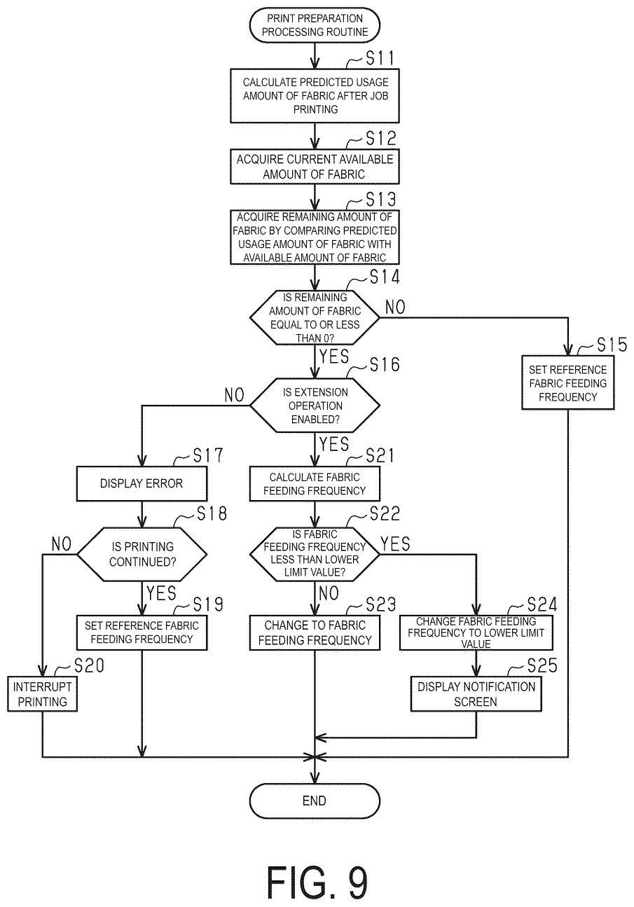

The storage unit 53 stores a program PR. The program PR is executed by the control unit 50 (more specifically, the computer 50C). The control unit 50 controls the printing apparatus 11 by causing the computer 50C to execute the program PR. This control includes printing control and display control. The program PR includes a program for a print preparation processing routine shown in a flowchart of FIG. 9. The print preparation processing is used to determine feeding conditions such as a timing and feed amount of the accommodation member 33 in the liquid accommodation unit 32. Details of the print preparation processing will be described later.

The control unit 50 performs printing control by controlling the liquid ejection unit 23 to eject liquid such as ink from the nozzles 24. When the printing apparatus 11 is a lateral printer, the control unit 50 may control the movement of the carriage 22 in the scanning direction X and the sub-scanning direction Y by controlling the movement mechanism 27. The control unit 50 controls the transport unit 18 so that the transport unit 18 transports the medium 99 in the scanning direction X during printing or between printings. Further, when the printing apparatus 11 is a serial printer, the transport unit 18 may transport the medium 99 in a direction (for example, Y direction or X direction) different from the scanning direction (for example, X direction or Y direction) of the liquid ejection unit 23.

The control unit 50 performs maintenance of the liquid ejection unit 23 at a predetermined time. The control unit 50 manages the predetermined time for performing maintenance. The control unit 50 manages a flushing timing, which is a time to perform flushing as one of the maintenance. The control unit 50 manages at least one of a medium printing length, a printing time, a printing amount, and the like from a time when the previous flushing has been completed. The control unit 50 determines that the flushing timing has been reached when at least one of the medium printing length, the printing time, the printing amount, and the like reaches a threshold. The control unit 50 may manage any one of the medium printing length, the printing time, and the printing amount, and determine that the flushing timing has been reached when one of such management targets reaches a threshold. As an example, the flushing timing may be managed by the printing time. In this case, the threshold may be set to a predetermined value (for example, 20 seconds) in a range of 5 seconds to 30 seconds. When the flushing timing arrives, the control unit 50 moves the carriage 22 to the flushing position FP and executes a flushing operation in which liquid is ejected from all the nozzles 24 of the liquid ejection unit 23 at the flushing position FP toward the accommodation member 33.

The flushed droplets are absorbed by the accommodation member 33 or deposited on the accommodation member 33. The accommodation member 33 becomes dirty with the liquid such as ink adhered during flushing. The amount of liquid flushed once is sufficiently small compared to the amount that the accommodation member 33 can accommodate. Therefore, flushing is performed multiple times on the same ejection target area of the accommodation member 33. The control unit 50 drives the drive unit 75 to feed the accommodation member 33 at a predetermined feed amount in the feed direction FD each time the amount of liquid adhering to the accommodation member 33 by flushing reaches a predetermined threshold. The control unit 50 changes the ejection target area of the accommodation member 33 that faces the nozzle surface 25 from a part that is dirty with the liquid IL to a new unused part through an operation of feeding the accommodation member 33.

For example, in FIG. 3, the liquid IL adheres to the ejection target area of the accommodation member 33 that faces the nozzle 24. The feed amount of the accommodation member 33 per time may be longer than the liquid adhering length of the ejection target area in the feed direction FD by a predetermined margin length, or may be approximately the same length as the liquid adhering length. Further, the feed amount of the accommodation member 33 per time may be shorter than the liquid adhering length. The control unit 50 drives the drive unit 75 by a predetermined drive amount each time the amount of liquid IL adhering to the ejection target area of the accommodation member 33 by flushing reaches the predetermined threshold, thereby feeding the accommodation member 33 in the feed direction FD by a predetermined feed amount. In the present embodiment, the feed amount of the accommodation member 33 is variable.

The control unit 50 determines whether the amount of liquid IL adhering to the ejection target area of the accommodation member 33 has reached the predetermined threshold. The amount of liquid IL adhering to the ejection target area of the accommodation member 33 can be determined based on a value of at least one parameter used for managing the flushing timing, such as the medium printing length, the printing time, and the printing amount, which have been measured from a point in time when the accommodation member 33 was previously fed. The control unit 50 resets a measured value of the parameter used to manage the flushing timing each time the accommodation member 33 is fed, and starts a new measurement.

The second counter 52 is used to measure a value (measured value) of the parameter that is used to manage the flushing timing. The control unit 50 resets the second counter 52 each time the operation of feeding the accommodation member 33 is performed. The control unit 50 causes the second counter 52 to count the measured value of the parameter. The control unit 50 acquires the measured value of the parameter based on the count value of the second counter 52. The control unit 50 controls the liquid accommodation unit 32 so that the operation of feeding the accommodation member 33 is performed once each time the count value of the second counter 52 reaches a predetermined threshold.

As described above, in the present embodiment, the operation of feeding the accommodation member 33 is performed intermittently each time a value of at least one parameter among the medium printing length, the printing time, the printing amount, and the like reaches a predetermined threshold. That is, the control unit 50 performs the intermittent feeding operation of feeding the accommodation member 33 intermittently. Here, a feed amount per unit of the accommodation member 33 is specified using one of the parameters of the medium printing length, the printing time, the printing amount, and the like as a unit. The control unit 50 feeds the accommodation member 33 at a predetermined feed amount per unit. As an example, when the unit is the medium printing length, the control unit 50 feeds the accommodation member 33 at a predetermined feed amount per unit of the medium printing length. Also, when the unit is the printing time, the control unit 50 feeds the accommodation member 33 at a predetermined feed amount per unit of the printing time. Further, when the unit is the printing amount, the control unit 50 feeds the accommodation member 33 at a predetermined feed amount per unit of the printing amount.

Further, the operation of feeding the accommodation member 33 is not limited to the intermittent feeding operation. The operation may be a constant speed feeding operation of feeding the accommodation member 33 at a constant speed. In short, it is sufficient when the feeding operation feeds the accommodation member 33 at a predetermined feed amount per unit. Here, in the present embodiment, a default (reference) is to set the predetermined feed amount of the accommodation member 33 per unit as a reference feed amount. By default, the control unit 50 performs the feeding operation of feeding the accommodation member 33 at the reference feed amount per unit.

When the control unit 50 receives the start signal for the print job PJ, the control unit 50 acquires the available amount of the accommodation member 33 that can be used for flushing and a predicted usage amount of the accommodation member 33 that is predicted to be used for flushing in the print job PJ. The predicted usage amount is acquired on the assumption that the accommodation member 33 is sent at the reference feed amount per unit. When the available amount is smaller than the predicted usage amount, the control unit 50 performs an extension operation of changing the reference feed amount per unit to the feed amount smaller than the reference feed amount per unit and executing the print job PJ.

In other words, the control unit 50 includes a function of performing an extension operation of extending a replacement timing of the accommodation member 33 by changing the feed amount per unit of the accommodation member 33 to the feed amount smaller than the reference feed amount. It is possible to extend the medium printing length that can be printed on the medium 99 until the amount of unused accommodation member 33 (available amount) reaches a replacement setting value C (end value) at which the accommodation member 33 should be replaced. In other words, it is possible to extend the feeding operation so that the replacement timing when the amount of unused accommodation member 33 reaches the replacement setting value C at which replacement of the accommodation member 33 is to be prompted can be postponed.

The liquid accommodation unit 32 performs a feeding operation that intermittently feeds the accommodation member 33 by a predetermined feed amount. The reference feed amount per unit is a reference frequency at which the feeding operation of feeding the accommodation member 33 by the reference feed amount is performed once per unit. For example, when the unit is the medium printing length, the reference frequency is a frequency at which the accommodation member 33 is fed once by the reference feed amount for each unit printing length. For example, when the unit is the printing time, the reference frequency is a frequency at which the accommodation member 33 is fed once by the reference feed amount for each unit printing time. For example, when the unit is the printing amount, the reference frequency is a frequency at which the accommodation member 33 is fed once by the reference feed amount for each unit printing amount. When the available amount is smaller than the predicted usage amount, the control unit 50 performs the extension operation of executing the print job PJ after changing the reference frequency to the feed amount smaller than the reference feed amount is performed.

In the extension operation, the feed amount per unit is changed to the feed amount smaller than the reference feed amount. In other words, the feed amount per unit changed by the extension operation is smaller than the reference feed amount per unit. Further, the feeding frequency defined by the feed amount per unit changed by the extension operation is set as the change frequency. The change frequency is smaller than the reference frequency.

The changed feed amount per unit is calculated so that the available amount of the accommodation member 33 becomes the replacement setting value C when the replacement of the accommodation member 33 is prompted at a time when the print job PJ has been completed. The changed frequency is calculated so that the available amount becomes 0 (zero) at a time when the print job PJ has been completed. Here, the available amount of “0” is not limited to exactly “0”, but is defined to include an available amount in a range that can be recognized as “0” in consideration of variations.

When the calculated feed amount per unit is equal to or less than the lower limit value, the control unit 50 changes the reference feed amount to the lower limit value and executes the print job PJ. When the control unit 50 changes the reference feed amount to the lower limit value, the control unit 50 displays on the display unit 61 that printing is interrupted. When the control unit 50 changes the reference feed amount to the lower limit value, the control unit 50 may display on the display unit 91 of the host apparatus 90 that printing is interrupted.

The extension operation is executed when the extension operation is enabled. The printing apparatus 11 is configured to be able to select whether or not to execute the extension operation using the selection unit 62. The user can select by operating the selection unit 62 whether to enable or disable the extension operation of postponing the replacement timing when the remaining amount (available amount) of the accommodation member 33 reaches the replacement setting value C until the printing based on the print job PJ has all been completed. When the execution of the extension operation is selected by the selection unit 62, the control unit 50 enables the extension operation.

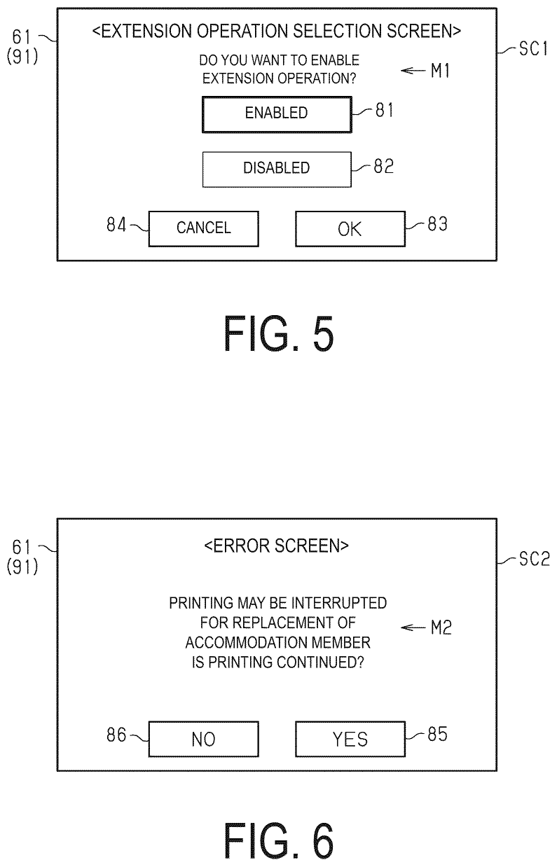

The control unit 50 performs display control for displaying various screens on the display unit 61. The control unit 50 causes the display unit 61 to display various screens including the screens SC1 to SC4 illustrated in FIGS. 5 to 8. The control unit 50 may cause the display unit 91 of the host apparatus 90 to display various screens including the screens SC1 to SC4 instead of or in addition to the display unit 61.

The control unit 50 causes the display unit 61 (91) to display the extension operation selection screen SC1 illustrated in FIG. 5 so that the user can select whether to enable or disable the extension operation regarding the operation of feeding the accommodation member 33. By displaying the extension operation selection screen SC1 illustrated in FIG. 5 on the display unit 61 (91), the user can set whether to enable or disable the extension operation by operating the selection unit 62. The extension operation selection screen SC1 includes an enable button 81 and a disable button 82. For example, the extension operation is set to be disabled by default. The extension operation selection screen SC1 illustrated in FIG. 5 includes a message M1 asking “Do you want to enable the extension operation?” For example, on the extension operation selection screen SC1 illustrated in FIG. 5, a user who wishes to enable the extension operation may enable the extension operation by selecting the enable button 81 by operating the selection unit 62. For example, on the touch panel display unit 61 (91), the user may touch the enable button 81 to select the enablement of the extension operation. When the user selects the enablement of the extension operation and then selects the OK button 83, the extension operation is set to be enabled. The control unit 50 may write whether the extension operation is enabled or disabled in a predetermined storage area of the storage unit 53, for example, as a flag value. The control unit 50 may determine whether the extension operation is enabled or disabled based on the value of the flag read from the predetermined storage area of the storage unit 53.

Further, when the control unit 50 predicts that the amount of unused accommodation member 33 will reach the end value during printing when the extension operation is disabled, the control unit 50 causes the display unit 61 (91) to display an error screen SC2 illustrated in FIG. 6. This error screen SC2 includes a message M2, a YES button 85, and a NO button 86.

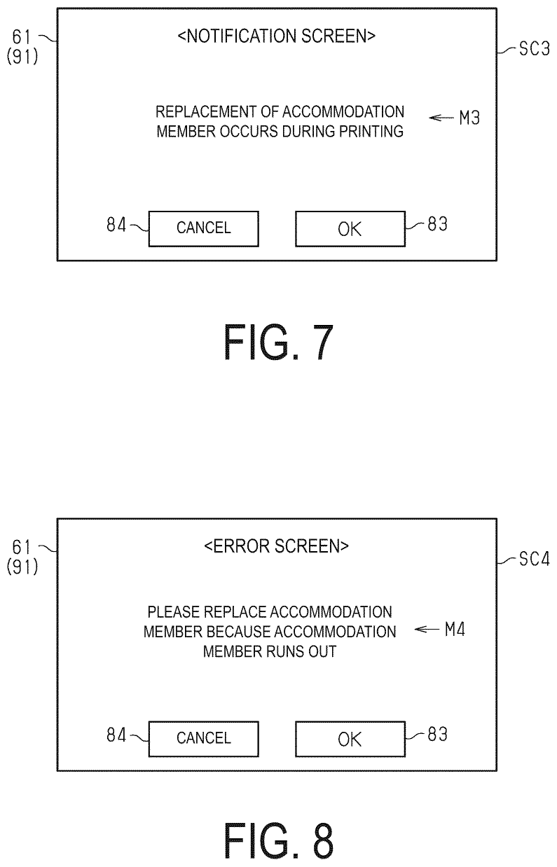

Further, the control unit 50 causes a notification screen SC3 (information screen) illustrated in FIG. 7 to be displayed. The control unit 50 can predict that the printing based on the print job PJ will be interrupted when the available amount, which is an actual amount of unused accommodation member 33 (remaining amount), is smaller than the predicted usage amount, which is the amount of unused accommodation member 33 required to complete all the printing based on the print job PJ. In this case, the control unit 50 causes the display unit 61 (91) to display the notification screen SC3 including a message M3 indicating that the accommodation member 33 will be replaced during printing, as illustrated in FIG. 7. The notification screen SC3 includes an OK button 83 and a cancel button 84.

The control unit 50 also displays an error screen SC4 as illustrated in FIG. 8. When the amount (remaining amount) of unused accommodation member 33 reaches the end value, the control unit 50 displays an error screen SC4 including a message M4 indicating “Please replace accommodation member 33 because the accommodation member 33 runs out” on the display unit 61 (91). The error screen SC4 includes an OK button 83 and a cancel button 84.

Further, the control unit 50 illustrated in FIG. 4 manages a cleaning timing, which is a timing to perform cleaning as one of maintenance procedures. The control unit 50 manages at least one of an elapsed time and a medium printing length from a point in time when the previous cleaning was performed. The control unit 50 determines that the cleaning timing has arrived when the elapsed time exceeds a predetermined time threshold. The control unit 50 also determines that the cleaning timing has arrived when the medium printing length exceeds a predetermined length threshold. The printing apparatus 11 may also include a nozzle inspection unit (illustrated in FIG. 1) that detects whether or not the nozzles 24 are clogged. In this case, when the nozzle inspection unit detects a clogged defective nozzle, the control unit 50 may determine that a time when the defective nozzle is detected is a cleaning timing. When the point in time is the cleaning timing, the control unit 50 causes the liquid ejection unit 23 to perform cleaning. That is, the control unit 50 moves the carriage 22, for example, to the retracted position CP, and then forcibly discharges the liquid from the nozzle 24 of the liquid ejection unit 23 that is at the retracted position CP. The discharge of the liquid from the nozzle 24 at this time may be pressure cleaning by the control unit 50 controlling the pressurizing unit 31, or suction cleaning by the control unit 50 controlling the suction pump. The cleaning may be performed by the liquid ejection unit 23 discharging the liquid from the nozzle 24 toward the accommodation member 33 of the liquid accommodation unit 32 at the flushing position FP.

Further, the control unit 50 manages the remaining amount of liquid in the liquid cartridge, which is an example of a liquid supply source. When the liquid cartridge is, for example, an ink cartridge, the control unit 50 manages the amount of ink remaining in the ink cartridge. When the liquid in the liquid cartridge reaches a preset end value, the control unit 50 displays information for prompting the user to replace the liquid cartridge on the display unit 61. The liquid supply source may be a liquid tank (for example, an ink tank). In this case, the control unit 50 manages the amount of liquid in the liquid tank. When the liquid in the liquid tank reaches a preset end value, the control unit 50 may display information for prompting the user to refill the liquid tank with liquid on the display unit 61.

The control unit 50 also manages the amount of unprinted medium 99 in the roll body 100 held on the feeding shaft 14 of the medium feeding unit 13. The printing apparatus 11 may include a detection unit (not shown), such as a weight sensor or an optical sensor, and may detect the amount of unprinted medium 99 in the roll body 100 based on a detection result of the detection unit. The control unit 50 may also manage the amount of unprinted medium 99 in the roll body 100 using the feed amount calculated based on an initial amount of the roll body 100 input by the user operating the selection unit 62 and an amount of rotation of the feeding shaft 14. Here, the initial amount input by the user may be, for example, an initial value with which a weight of the roll body 100 in the medium feeding unit 13, a medium winding length, a roll diameter, or the like can be specified. The initial value may be a product number of the roll body 100 and information indicating that a product has been replaced with a new one. When the amount of the roll body 100 in the medium feeding unit 13 reaches a preset end value, the control unit 50 displays information for prompting the user to replace the roll body 100 on the display unit 61.

Here, the cleaning operation, the replacement/replenishment of the liquid supply source by the user, and the replacement of the roll body 100 by the user are interruption operations of interrupting printing. When one of the interruption operations should be performed, the control unit 50 interrupts the printing operation if printing is in progress. When the control unit 50 detects that the interruption operation causing the interruption has been completed after a print operation is interrupted, the control unit 50 resumes the interrupted printing operation. Replacement of the accommodation member 33 when the amount of unused accommodation member 33 reaches the replacement setting value C also interrupts the printing operation. In the present embodiment, the interruption of printing when the amount of unused accommodation member 33 reaches the replacement setting value C is curbed through execution of the extension operation described above.

### Operation of First Embodiment

Next, an operation of the printing apparatus 11 in the first embodiment will be described with reference to FIGS. 1 to 9. Hereinafter, the print preparation processing routine executed by the control unit 50 will be described with reference to FIG. 9. In detail, the computer 50C of the control unit 50 executes the print preparation processing routine. This print preparation processing routine is a process of setting a feeding frequency as an example of the feed amount per unit of the accommodation member 33. When the control unit 50 receives the start signal for the print job PJ, the control unit 50 executes the print preparation processing routine. In this print preparation process, the control unit 50 sets the feeding frequency of the accommodation member 33 to be used during printing based on the received print job PJ. Hereinafter, the accommodation member 33 is assumed to be fabric 33A as an example. Therefore, in the flowchart illustrated in FIG. 9, a “predicted usage amount of the accommodation member 33” is also referred to as a “predicted usage amount of fabric”, an “available amount of the accommodation member 33” is also referred to as an “available amount of fabric”, a “remaining amount of the accommodation member 33” is also referred to as a “remaining amount of fabric”, a “reference feeding frequency of the accommodation member 33” is also referred to as a “reference fabric feeding frequency”, and a “feeding frequency of the accommodation member 33” is also referred to as a “fabric feeding frequency”. Further, an example in which the replacement setting value C at which the accommodation member 33 is to be replaced is set to “0 (zero)” is shown.

When the control unit 50 receives one or more print jobs PJ, the control unit 50 executes the print preparation processing routine shown in the flowchart in FIG. 9. In this print preparation processing routine, the control unit 50 performs the print preparation process based on the next print job PJ to be executed among the one or more print jobs PJ for which the start signal has been received.

First, in step S11, the control unit 50 calculates the predicted usage amount of fabric 33A after the job printing. For example, the control unit 50 calculates the predicted usage amount of fabric 33A at a time when printing based on one print job PJ has all been completed.

In the next step S12, the control unit 50 acquires the current available amount of the accommodation member 33 (for example, the available amount of fabric). The control unit 50 acquires, for example, the current remaining amount of fabric. In the present embodiment, the processes of steps S11 and S12 correspond to “acquiring the available amount of the accommodation member 33 that can be used for flushing, and the predicted usage amount of the accommodation member 33 predicted to be used for flushing in the print job PJ when the accommodation member 33 is sent at the reference feed amount per unit when the start signal for the print job PJ is received”.

In the next step S13, the control unit 50 compares the predicted usage amount of fabric 33A with the available amount to acquire the remaining amount of fabric. For example, the control unit 50 acquires the remaining amount of fabric after printing by subtracting the predicted usage amount of fabric 33A from the available amount of fabric 33A at the start of the current print job PJ. For example, when the fabric 33A runs short before the printing based on the print job PJ has been completed, the calculated remaining amount of fabric will be less than 0.

In step S14, the control unit 50 determines whether the remaining amount of fabric after printing is 0 (zero) or less. In other words, the control unit 50 determines whether the remaining amount of fabric that is a calculation result in step S13 is equal to or less than the replacement setting value C (for example, 0). When the remaining amount of fabric is not equal to or less than the replacement setting value C (for example, 0) (that is, when the remaining amount of fabric exceeds the replacement setting value C), the control unit 50 proceeds to step S15. On the other hand, when the remaining amount of fabric is equal to or less than the replacement setting value C (for example, 0), the control unit 50 proceeds to step S16.

Here, the replacement setting value C, which is a remaining amount when the user is prompted to replace the accommodation member 33, is set to “0” for convenience. The replacement setting value C may be 0 or may not be 0. In short, the replacement setting value C may be a remaining amount (remaining amount of fabric) of the accommodation member 33 set to prompt the user to replace the accommodation member 33. This replacement setting value C may be a value obtained by adding some margin to 0. For example, the replacement setting value C may be 1 cm, 5 cm, 10 cm, or the like. Further, the replacement setting value C greater than 0 may be a dimension of a nozzle formation area (in other words, an ejection target area) in which a plurality of nozzles 24 are formed in the feed direction FD on the nozzle surface 25 of the liquid ejection unit 23. Thus, the replacement setting value C may be a value greater than 0. Therefore, a unit of the extension operation, or the replacement setting value C may be a value greater than 0 (for example, 5 cm), and a determination may be made in step S14 whether the remaining amount of fabric is equal to or less than the replacement setting value C.

In step S15, the control unit 50 sets the reference fabric feeding frequency. By default, the reference fabric feeding frequency is set. A process of setting the reference fabric feeding frequency includes, for example, a process of returning the reference fabric feeding frequency to a default reference fabric feeding frequency when a feeding frequency other than the reference fabric feeding frequency has been set in the printing based on the previous print job PJ. In other words, when there is no shortage of the accommodation member 33 when the printing based on the print job PJ is performed, the feed amount per unit of the accommodation member 33 is set to the reference feed amount. In the present embodiment in which the accommodation member 33 is fed intermittently, the accommodation member 33 is set to be fed at the reference feeding frequency. For example, in an example in which the accommodation member 33 is fabric, the control unit 50 sets the reference fabric feeding frequency.

In step S16, the control unit 50 determines whether or not the extension operation is enabled. When the control unit 50 determines that the extension operation is not enabled (that is, that the extension operation is disabled), the process proceeds to step S17. On the other hand, when the control unit 50 determines that the extension operation is enabled, the process proceeds to step S21.

The user sets whether to enable or disable the extension operation by operating the selection unit 62 by causing the extension operation selection screen SC1 illustrated in FIG. 5 to be displayed on the display unit 61 (91) in advance. For example, the extension operation is set to be disabled by default, and a user who wants to enable the extension operation may select enable by operating the selection unit 62. For example, on the extension operation selection screen SC1 illustrated in FIG. 5, the user performs an operation to select the enable button 81 using the selection unit 62. For example, when the display unit 61 (91) is a touch panel, the user may select the enable of the extension operation by touching the enable button 81. The user selects the OK button 83 with the enable button 81 selected. The control unit 50, which has received this selection signal, sets the extension operation to enabled. For example, information (for example, a flag value) regarding whether the extension operation is enabled or disabled is stored in the predetermined storage area of the storage unit 53. In the determination process of step S16, the control unit 50 may determine whether or not the extension operation is enabled based on, for example, the value of the flag read from the predetermined storage area of the storage unit 53.

When the extension operation is disabled (step S16: NO), the control unit 50 proceeds from step S16 to step S17 and executes the processes of steps S17 to S20.

Specifically, in step S17, the control unit 50 displays an error. That is, the control unit 50 causes the display unit 61 (91) to display the error screen SC2 illustrated in FIG. 6. The user reads the message M2 on the error screen SC2 displayed on the display unit 61 (91). This error screen SC2 includes a message M2 for confirming to the user whether to continue printing despite a likelihood that printing may be interrupted due to replacement of the accommodation member 33. When the user wishes to continue printing even when printing is interrupted, the user selects the YES button 85 on the error screen SC2 by operating the selection unit 62. On the other hand, when the user does not wish to interrupt the printing, the user operates the selection unit 62 to select the NO button 86 on the error screen SC2 to indicate that the user does not wish to continue the printing. The control unit 50, which has received an operation signal based on an operation with respect to the selection unit 62 by the user, executes the process of step S18.

That is, in step S18, the control unit 50 determines whether or not to continue the printing. When the control unit 50 receives an operation signal when the user operates the YES button 85 on the error screen SC2 to indicate that the user wishes to continue the printing, the control unit 50 determines that the selection to continue the printing has been made. On the other hand, when the control unit 50 receives an operation signal when the user operates the NO button 86 on the error screen SC2 to indicate that the user wishes not to continue the printing, the control unit 50 determines that the selection to not continue the printing has been made. When the control unit 50 determines that the selection to continue the printing has been made (step S18: YES), the control unit 50 proceeds to step S19. On the other hand, when the control unit 50 determines that the selection to continue the printing has not been made (step S18: NO), the control unit 50 proceeds to step S20.

In step S19, the control unit 50 sets the reference fabric feeding frequency. That is, the control unit 50 sets that the accommodation member 33 is fed at the reference feed amount per unit. When the accommodation member 33 is fabric, the control unit 50 sets that the fabric is fed at the reference feed amount per unit. For example, in a configuration in which the fabric is intermittently fed at the reference feed amount per unit, the reference fabric feeding frequency is set. The reference fabric feeding frequency is, for example, a default feeding frequency. In other words, in step S19, the control unit 50 sets the same reference fabric feeding frequency as in step S15. In this case, since the reference fabric feeding frequency is set when the remaining amount of fabric is 0 or less (step S14: YES), there is a likelihood that printing is interrupted to replace the accommodation member 33 when the printing is continued as is.

On the other hand, in step S20, the control unit 50 interrupts the printing. That is, when the control unit 50 receives an operation signal indicating that printing will not be continued from the selection unit 62, the control unit 50 interrupts the print job PJ without executing the print job PJ even when the start signal for the print job PJ has been received. In this case, for example, the user may select enabling the extension operation on the extension operation selection screen SC1 illustrated in FIG. 5, and may try whether the print job PJ can be executed without interrupting the printing through implementation of the extension operation. Further, the printing length, the number of times of printing, or the number of printed sheets that can be printed at the reference fabric feeding frequency for the image designated in the print job PJ may be displayed on the error screen SC2 illustrated in FIG. 6, which is displayed in step S17. In this case, the user may re-instruct the print job PJ in which the printing condition information has been changed to the displayed printing length, number of times of printing, or the like. Further, the control unit 50 may determine whether the print job PJ can be completed without interruption when the extension operation is performed. When the control unit 50 determines that the print job PJ can be completed without interruption, the control unit 50 may display information such as a message for recommending a selection for enabling the extension operation on the error screen SC2 illustrated in FIG. 6 or another guide screen.

On the other hand, in step S21, the control unit 50 calculates the fabric feeding frequency as a process when the extension operation is enabled (step S16: YES). That is, the control unit 50 calculates the fabric feeding frequency at which all the printing based on the print job PJ can be completed before the remaining amount of fabric reaches the replacement setting value C (for example, 0) at which the accommodation member 33 (fabric 33A) should be replaced. This fabric feeding frequency is calculated as a value smaller than the reference fabric feeding frequency. In a configuration in which the fabric 33A is intermittently fed by the feed amount, the feed amount per unit of the fabric 33A is given at the fabric feeding frequency at which the fabric 33A is fed once at a predetermined feed amount per unit. For example, when the unit is the printing length, the fabric feeding frequency is a frequency at which the fabric 33A is fed once at a predetermined feed amount for each unit printing length.

For example, the predicted usage amount acquired in step S11 is ΔL1, and the available amount acquired in step S12 is ΔL2. Further, the reference fabric feeding frequency is F0. In this case, a fabric feeding frequency F1 is calculated by Formula F1=(ΔL2/ΔL1)*F0. As an example, the reference fabric feeding frequency F0 is assumed to be a frequency at which the fabric 33A is fed once at a specified feed amount (for example, 20 cm) for every 10 m of the printing length of the medium 99. In this case, for example, the unit printing length is 10 m. The predicted usage amount ΔL1 is 1 m, and the available amount ΔL2 is 0.5 m. In this case, ΔL2/ΔL1 in Formula F1=(ΔL2/ΔL1)*F0 is 0.5. Accordingly, the fabric feeding frequency F1 is given by F1=F0/2. In other words, the fabric feeding frequency F1 is ½ of the reference fabric feeding frequency. In the above example in which the reference fabric feeding frequency F0 is once for every 10 m of the printing length, F0=1 (times/10 m) is shown. In this case, when F1=F0/2, the fabric feeding frequency F1 is given as 0.5 (times/10 m).

Here, the number of times the fabric 33A is fed is a natural number. Therefore, the fabric feeding frequency F1=0.5 is, for example, a frequency at which the fabric 33A is fed once at a predetermined feed amount (for example, 20 cm) for every 20 m of the printing length of the medium 99. Thus, the fabric feeding frequency F1 (an example of the change frequency) is (ΔL2/ΔL1) times the reference fabric feeding frequency F0 (an example of the reference frequency). The “unit” and “feed amount” may be selected as appropriate values depending on a model, machine size, printing resolution, ink type, and size of the liquid ejection unit 23 (for example, a dimension of the nozzle formation area) of the printing apparatus 11. Here, an example in which the feeding operation is the intermittent feeding operation is shown, but the feeding operation may be a constant speed feeding operation. In other words, it is sufficient that the accommodation member 33 is fed at a predetermined feed amount per unit.

In the next step S22, the control unit 50 determines whether the calculated fabric feeding frequency is less than the lower limit value. When the fabric feeding frequency is not less than the lower limit value (step S22: NO), the control unit 50 proceeds to step S23. On the other hand, when the fabric feeding frequency is less than the lower limit value (step S22: YES), the control unit 50 proceeds to step S24.

In step S23, the control unit 50 changes the fabric feeding frequency to the calculated frequency. In the present embodiment, the processes of steps S13, S14 (YES), S16 (YES), S21, and S23 correspond to “performing an extension operation of changing the reference feed amount per unit to a feed amount smaller than the reference feed amount per unit and executing the print job PJ when the available amount is smaller than the predicted usage amount”.

On the other hand, in step S24, the control unit 50 changes the fabric feeding frequency to the lower limit value instead of the calculated frequency. That is, the control unit 50 changes the reference fabric feeding frequency to the lower limit value of the feeding frequency.

When the fabric feeding frequency is changed to the lower limit value in this way, the control unit 50 causes the display unit 61 (91) to display the notification screen SC3 illustrated in FIG. 7 in the next step S25. The notification screen SC3 includes a message M3 indicating that the accommodation member 33 (for example, fabric) will be replaced during printing. After the user confirms that the accommodation member 33 will be replaced during printing, the user selects the OK button 83 on the notification screen SC3 by operating the selection unit 62. The control unit 50 may determine to set the lower limit value as the fabric feeding frequency when an operation signal indicating that the OK button 83 on the notification screen SC3 has been operated is received.

### Printing Operation

When the control unit 50 thus ends the print preparation process, the control unit 50 executes the printing instructed in the print job PJ. That is, the control unit 50 executes the printing instructed in the print job PJ. During this printing, the liquid accommodation unit 32 is controlled based on the set content set in the print preparation process.

In detail, the print job PJ includes the image data and the printing condition information. The control unit 50 executes printing of an image based on the image data designated in the print job PJ according to the print conditions designated in the printing condition information. The control unit 50 executes this printing and feeds the accommodation member 33 (for example, fabric) at the feed amount per unit (for example, fabric feeding frequency) set in the print preparation process.

For example, when there is a sufficient remaining amount of the accommodation member 33 (remaining amount of fabric) for the printing length defined in the print job PJ, the fabric 33A is fed at the reference fabric feeding frequency set in step S15. In other words, the fabric 33A is fed at the default feeding frequency. In detail, the printing length is used as a unit, and a feeding operation for the fabric 33A is performed at a frequency at which the fabric 33A is fed at the reference feed amount per unit printing length.

In this case, the control unit 50 measures the printing length from a point in time when a previous feeding operation for the fabric 33A was performed. When the printing length reaches the unit length, the control unit 50 feeds the fabric 33A by the reference feed amount. That is, the control unit 50 drives the motor 75M of the liquid accommodation unit 32 by a reference drive amount to perform a feeding operation of feeding the fabric 33A by the reference feed amount.

On the other hand, when the remaining amount of fabric is insufficient (step S14: YES) and the extension operation is enabled (step S16: YES), the fabric feeding frequency is set (steps S21 to S23). In other words, the reference fabric feeding frequency is changed to a fabric feeding frequency smaller than this reference fabric feeding frequency (step S23). In this case, the fabric 33A is fed at the changed fabric feeding frequency during printing.

The fabric feeding frequency is adjusted to a value at which the remaining amount of fabric at a time when the printing based on the print job PJ has all been completed exactly reaches the replacement setting value C (for example, 0). In other words, an extension operation of extending a replacement timing of the fabric 33A is adopted. Therefore, when the printing of an image based on the print job PJ has been completed for a designated number of times of printings, the printing is stopped. At the time of stopping the printing, the remaining amount of fabric 33A exactly reaches the replacement setting value C. Therefore, the control unit 50 displays the error screen SC4 illustrated in FIG. 8 for prompting the accommodation member 33 (fabric 33A) to be replaced on the display unit 61 (91). Therefore, since the user does not need to replace the fabric 33A during printing, interruption of the printing based on the print job PJ can be avoided. Therefore, it is not necessary to replace the fabric 33A in advance before the start of the print job PJ in order to avoid interruption of printing. Further, the frequency at which the fabric 33A of the liquid accommodation unit 32 can be used up increases. Therefore, the fabric 33A can be used effectively without waste. This also leads to a reduction in the frequency of replacing the fabric 33A of the liquid accommodation unit 32.

The user reading the message M4 on the error screen SC4 displayed on the display unit 61 (91) replaces the fabric 33A. For example, when the liquid accommodation unit 32 is configured so that only the fabric 33A can be replaced, the used first roll body 72 (for example, a core material) is removed from the winding unit 36, and a new first roll body 72 is set in the feeding unit 35. On the other hand, when the liquid accommodation unit 32 is configured to be replaced on a unit basis, the user replaces the used liquid accommodation unit 32 with a new liquid accommodation unit 32.

When the replacement of the accommodation member 33 has ended, the OK button 83 is operated on the error screen SC4 illustrated in FIG. 8. Then, the control unit 50 performs a process of checking whether the replacement of the fabric 33A or the replacement of the liquid accommodation unit 32 has been performed. When the control unit 50 confirms that the replacement of the fabric 33A or the replacement of the liquid accommodation unit 32 has been performed correctly, the control unit 50 starts printing based on the next print job PJ when the control unit 50 has received a start signal for the next print job PJ.

Also, when the calculated fabric feeding frequency is less than the lower limit value (step 22: YES), the reference fabric feeding frequency is changed to the lower limit value of the feeding frequency. Therefore, the fabric 33A is fed at a fabric feeding frequency of the lower limit value. Therefore, for example, when the liquid is a liquid that dries easily, such as resin ink, problems such as deposits on the fabric 33A containing thickened or dried matter of the liquid IL due to flushing coming into contact with the nozzle surface 25 of the liquid ejection unit 23 can be avoided. In other words, the feeding operation for the fabric 33A is performed before the deposit on the fabric 33A comes into contact with the nozzle surface 25. As a result, problems such as the deposit on the fabric 33A coming into contact with the nozzle surface 25 of the liquid ejection unit 23 can be reliably avoided. Also, for example, when the liquid is a liquid that is not dried easily, such as a water-based ink, the liquid IL is absorbed by the fabric 33A due to flushing. The feeding operation for the fabric 33A is performed before the amount of liquid IL absorbed by the fabric 33A exceeds a predetermined value and before the elapsed time from the start of liquid absorption exceeds a predetermined time. Accordingly, occurrence of liquid leakage, such as the liquid absorbed by the fabric 33A dripping from a lower surface of the fabric 33A due to its own weight is curbed.

However, when a lower limit value is set for the feeding frequency of the fabric 33A, the printing based on the print job PJ is likely to be interrupted. Therefore, the user is notified that the printing is likely to be interrupted on the notification screen SC3 (FIG. 7). Accordingly, the user can know in advance that printing is interrupted despite the extension operation being enabled, and that a printing operation contrary to the user's intention will be performed. In other words, the user can continue the printing to use up all of the fabric 33A without waste, after accepting that printing is interrupted.

Further, when the user sets the extension operation to be disabled (step S16: NO), the user can select whether to continue the printing on the error screen SC2 illustrated in FIG. 6. Therefore, in this case, the user can know in advance that printing is interrupted and that a printing operation contrary to the user's intention will be performed. In other words, the user can continue printing to use up all of the fabric 33A without waste, after accepting that printing is interrupted.

### Effects of First Embodiment

Therefore, according to this first embodiment, the following effects can be obtained.

(1-1) The printing apparatus 11 includes the liquid ejection unit 23 that ejects the liquid to perform printing on the medium 99, the liquid accommodation unit 32, and the control unit 50. The liquid accommodation unit 32 includes the accommodation member 33 that accommodates the liquid that the liquid ejection unit 23 ejects in flushing regardless of the printing, the feeding unit 35 in which the accommodation member 33 is set, and the winding unit 36 that winds the accommodation member 33. When the control unit 50 acquires the available amount of the accommodation member 33 that can be used for flushing, and the predicted usage amount of the accommodation member 33 predicted to be used for flushing in the print job PJ when the accommodation member 33 is sent at the reference feed amount per unit when the control unit 50 receives the start signal for the print job PJ. The control unit 50 performs an extension operation of changing the reference feed amount per unit to a feed amount smaller than the reference feed amount per unit and executing the print job PJ when the available amount is smaller than the predicted usage amount. With this configuration, it is possible to curb concern that printing is interrupted due to runout of the available accommodation member 33 during printing, by changing the feed amount per unit of the accommodation member 33 according to the available amount.

(1-2) The liquid accommodation unit 32 performs a feeding operation that intermittently feeds the accommodation member 33 by a predetermined feed amount. The reference feed amount per unit is a reference frequency at which a feeding operation of feeding the accommodation member 33 at the reference feed amount per unit is performed once. When the available amount is smaller than the predicted usage amount, the extension operation of executing the print job PJ after changing the reference frequency to the feed amount smaller than the reference feed amount is performed. With this configuration, it is possible to curb concern that an incomplete amount remains and the printing is interrupted when the next print job PJ is executed by using up the accommodation member 33 to an amount reaching the replacement timing.

(1-3) The changed feed amount per unit is calculated so that the available amount at a time when the print job PJ has been completed becomes the replacement setting value C when replacement of the accommodation member 33 is prompted. With this configuration, it is possible to curb concern that an incomplete amount remains and the printing is interrupted when the next print job PJ is executed by using up the accommodation member 33 to the amount reaching the replacement timing.

(1-4) The change frequency is calculated so that the available amount becomes zero at a time when the print job PJ has been completed. With this configuration, it is possible to curb concern that an incomplete amount remains and the printing is interrupted when the next print job PJ is executed by using up the accommodation member 33.

(1-5) When the calculated feed amount per unit is equal to or less than the lower limit value, the control unit 50 changes the reference feed amount to the lower limit value and executes the print job PJ. With this configuration, when the feed amount per unit of the accommodation member 33 is reduced too much, there is concern that a liquid leaks from the accommodation member 33 or a dried matter of the liquid or the like is deposited on the accommodation member 33, but this can be prevented. For example, when the liquid is a liquid that is difficult to dry, such as a water-based ink, concern that the liquid absorbed by the accommodation member 33 leaks from the accommodation member 33 due to its own weight can be prevented. Further, for example, when the liquid is a liquid that is dried easily such as resin ink, concern that the dried matter of the liquid or the like is deposited excessively on the accommodation member 33 as the dried matter comes into contact with the nozzle surface 25 of the liquid ejection unit 23 can be prevented.

(1-6) The printing apparatus 11 includes a display unit 61 that displays information. When the control unit 50 changes the reference feed amount to the lower limit value, the fact that the printing is interrupted is displayed on the display unit 61. With this configuration, the user can be aware of the interruption of the printing in advance, thereby improving usability for the user. For example, the user can be aware of the interruption of the printing due to the replacement of the accommodation member 33 during the printing in advance. Therefore, for example, the user can select whether to continue printing as is or to interrupt the printing and replace the accommodation member 33.

(1-7) The extension operation is executed when the execution of the extension operation is enabled. With this configuration, the extension operation is executed only when the extension operation is enabled so that productivity can be improved compared to when the extension operation is disabled.

(1-8) The printing apparatus 11 includes a selection unit 62 that selects whether or not to execute the extension operation. The control unit 50 enables the execution of the extension operation when the execution of the extension operation is selected by the selection unit 62. With this configuration, the execution of the extension operation can be selected by the selection unit 62, thereby improving usability for the user.

(1-9) The printing apparatus 11 includes a liquid ejection unit 23 and a liquid accommodation unit 32. The liquid accommodation unit 32 includes an accommodation member 33 that accommodates a liquid, a feeding unit 35 in which the accommodation member 33 is set, and a winding unit that winds the accommodation member 33. The control method for the printing apparatus 11 includes the following (a) and (b).
(a) The available amount of the accommodation member 33 that can be used for flushing, and the predicted usage amount of the accommodation member 33 predicted to be used for flushing in the print job PJ when the accommodation member 33 is sent at the reference feed amount per unit are acquired when the start signal for the print job PJ is received.
(b) An extension operation of changing the reference feed amount per unit to a feed amount smaller than the reference feed amount per unit and executing the print job PJ is performed when the available amount is smaller than the predicted usage amount. With this method, it is possible to curb concern that printing is interrupted due to runout of the available accommodation member 33 during printing by changing the feed amount per unit of the accommodation member 33 according to the available amount of the accommodation member 33.

(1-10) The control method for the printing apparatus 11 may include the following (c).
(c) The changed feed amount per unit is calculated so that the available amount at a time when the print job PJ has been completed becomes the replacement setting value C when replacement of the accommodation member 33 is prompted. With this method, it is possible to curb concern that an incomplete amount of the accommodation member 33 remains and the printing is interrupted when the next print job PJ is executed by using up the accommodation member 33 until the amount reaching the replacement timing.

### Second Embodiment

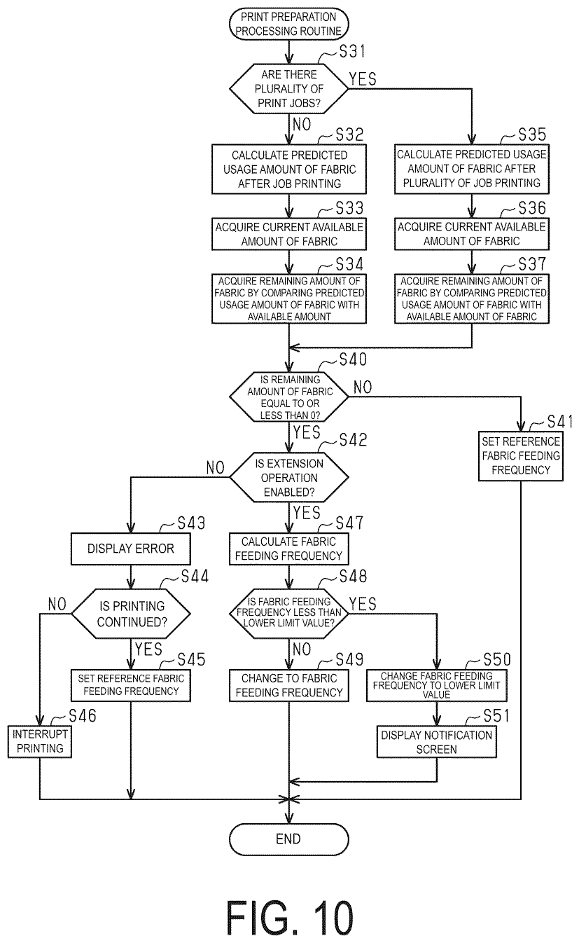

Next, a printing apparatus 11 of a second embodiment will be described with reference to FIG. 10. The second embodiment differs from the first embodiment in the content of the print preparation processing routine. In the first embodiment, the fabric feeding frequency has been set as an example of the feed amount per unit of the accommodation member 33, based on a comparison result between the predicted usage amount of the accommodation member 33 required to end all printing based on one print job PJ and the available amount. On the other hand, in the second embodiment, when a start signal for the plurality of print jobs PJ is received, the fabric feeding frequency is set as an example of the feed amount per unit of the accommodation member 33 based on a comparison result between the predicted usage amount of the fabric 33A required to end all printing based on the plurality of print jobs PJ and the available amount. That is, when the control unit 50 receives the start signal for the plurality of print jobs PJ, the control unit 50 acquires the available amount of the accommodation member 33 and the predicted usage amount of the accommodation member 33 in the plurality of print jobs PJ. The control unit 50 performs an extension operation of changing the reference feed amount per unit to the feed amount smaller than the reference feed amount per unit and executing the plurality of print jobs PJ when the available amount of the accommodation member 33 is smaller than the predicted usage amount. Other configurations other than the print preparation process are the same as those in the first embodiment. Hereinafter, the print preparation process of the second embodiment will be described. The accommodation member 33 is an example of the fabric 33A as in the first embodiment. Further, the reference feed amount per unit is an example of the reference fabric feeding frequency (an example of the reference frequency), and the feed amount per unit of the accommodation member 33 is an example of the fabric feeding frequency (an example of the change frequency), as in the first embodiment. Further, an example in which the replacement setting value C is 0 (zero) will be described.

When the control unit 50 receives a start signal for one or more print jobs PJ, the control unit 50 executes a print preparation processing routine shown in a flowchart of FIG. 10. In detail, the computer 50C constituting the control unit 50 executes the print preparation processing routine.

First, in step S31, the control unit 50 determines whether there are the plurality of print jobs PJ. When only one print job PJ has been received, the control unit 50 proceeds to step S32. On the other hand, when the plurality of print jobs PJ have been received, the control unit 50 proceeds to step S35.

When only one print job PJ has been received, the control unit 50 executes the processes of steps S32 to S34. In other words, the control unit 50 executes the same processes as steps S11 to S13 in the first embodiment through the processes of steps S32 to S34. Through these processes, the control unit 50 calculates the predicted usage amount of fabric 33A when printing of one print job PJ has been completed (step S32). The control unit 50 acquires the current (at the start of the job) available amount of fabric 33A (step S33). The predicted usage amount and the available amount of fabric 33A are compared with each other. Through the comparison of the predicted usage amount with the available amount of fabric 33A, the remaining amount of fabric at a time when printing by the current print job PJ has been completed is acquired. For example, the control unit 50 subtracts the predicted usage amount from the available amount of fabric 33A (step S34). When there is a shortage of fabric 33A, a calculation result thereof will be less than 0.

On the other hand, when there are a plurality of received print jobs PJ, the control unit 50 executes the processes of steps S35 to S37. In other words, the control unit 50 compares the predicted usage amount of fabric 33A required to complete the plurality of print jobs PJ with the available amount of fabric 33A at the start of the plurality of print jobs PJ through the processes of steps S35 to S37. For example, the control unit 50 acquires the remaining amount of fabric by subtracting the predicted usage amount from the available amount of fabric 33A.

The processes of steps S40 to S51 are the same as those of steps S14 to S25 in the first embodiment.

In step S40, the control unit 50 determines whether the remaining amount of fabric acquired in step S34 is equal to or less than the replacement setting value C (for example, 0) when there is one print job PJ. On the other hand, the control unit 50 determines whether the remaining amount of fabric acquired in step S37 is equal to or less than the replacement setting value C (for example, 0) when there are the plurality of print jobs PJ.

When the remaining amount of fabric is equal to or less than the replacement setting value C (step S40: YES), the control unit 50 determines whether the extension operation is enabled in step S42. When the extension operation is enabled (step S42: YES), the fabric feeding frequency at which the remaining amount of fabric at a point in time of printing completion can exactly be the replacement setting value C is calculated (step S47). This changed fabric feeding frequency (change frequency) is calculated as a value smaller than the reference fabric feeding frequency (reference frequency). For example, when the start signal for the plurality of print jobs PJ has been received (step S31: YES), the control unit 50 adjusts the feeding frequency of the fabric 33A so that the remaining amount of fabric reaches the replacement setting value C when the printing based on the plurality of print jobs PJ has all been completed.

When the calculated fabric feeding frequency is not less than the lower limit value (step S48: NO), the control unit 50 changes the reference feeding frequency to the fabric feeding frequency (step S49). On the other hand, when the calculated fabric feeding frequency is less than the lower limit value (step S48: YES), the control unit 50 changes the feeding frequency to be changed from the reference feeding frequency to the lower limit value (step S50). When the reference fabric feeding frequency is changed to the lower limit value, the control unit 50 displays the notification screen SC3 illustrated in FIG. 7 on the display unit 61 (91) in step S51.

When the extension operation is enabled (step S42: NO), the control unit 50 executes the processes of steps S43 to S46. The processes of steps S43 to S46 are the same as the processes of steps S17 to S20 in the first embodiment. Further, in step S40, when the remaining amount of fabric is not 0 or less (step S40: NO), the control unit 50 sets the reference fabric feeding frequency. In other words, the control unit 50 sets the reference feed amount per unit.

Thus, when the control unit 50 ends the print preparation process, the control unit 50 executes the print job PJ. During the execution of this print job PJ, the control unit 50 controls the liquid accommodation unit 32 so that a feeding operation of feeding the fabric 33A at the fabric feeding frequency set in the print preparation process is performed. The feeding operation for the fabric 33A is basically the same as that of the first embodiment, but the second embodiment differs from the first embodiment in that, when there are the plurality of print jobs PJ, an extension operation of adjusting the feed amount (feeding frequency) to postpone the replacement timing of the accommodation member 33 until all printing based on the plurality of print jobs PJ has been completed is performed.

In detail, when there are the plurality of print jobs PJ, the feeding frequency of the accommodation member 33 is set so that the remaining amount of the accommodation member 33 reaches the replacement setting value C at a time when printing of the image data designated in the plurality of print jobs PJ has been completed for all the designated number of times of printing in the processes of steps S35 to S37. Specifically, the control unit 50 executes a process in the next procedure. The predicted usage amount of the fabric 33A at a time when printing of the image data designated in the plurality of print jobs PJ has been completed for all the designated number of times of printing is calculated (step S35). The predicted usage amount of fabric 33A is compared with the available amount of fabric 33A at a time when the plurality of print jobs PJ start so that the remaining amount of fabric after the plurality of print jobs are acquired (step S37). For example, the control unit 50 acquires the remaining amount of fabric by subtracting the predicted usage amount from the available amount of fabric 33A at a time when the job starts.

When the remaining amount of fabric is 0 or less (step S40: YES) and the extension operation is enabled (step S42: YES), the reference fabric feeding frequency is changed to the fabric feeding frequency with a smaller value (step S49). The fabric feeding frequency at this time is calculated as a value at which the fabric 33A exactly reaches the replacement setting value C when the printing based on the plurality of print jobs PJ has all been completed. Therefore, printing based on the plurality of print jobs PJ can all be completed without replacing the fabric 33A midway.

Thus, in the second embodiment, when there are the plurality of print jobs PJ, the feed amount of the fabric 33A is adjusted so that the remaining amount of fabric reaches the replacement setting value C at a time when the printing based on the plurality of print jobs PJ has all been completed. The extension operation is performed at the adjusted feed amount. Therefore, at a time when the printing of images based on the plurality of print jobs PJ has all been completed, the printing is stopped and the remaining amount of fabric 33A reaches the replacement setting value C. Therefore, the control unit 50 displays the error screen SC4 illustrated in FIG. 8, which prompts the user to replace the accommodation member 33 (fabric 33A). Thus, the user does not need to replace the fabric 33A in the middle of the printing based on the plurality of print jobs PJ for which the start signal has been received. In other words, interruption of the printing based on the plurality of print jobs PJ can be avoided. For example, a frequency at which the fabric 33A can be used up increases.

When the fabric feeding frequency acquired in steps S35 to S37, S40, S42, and S47 is less than the lower limit value (step S48: YES), the control unit 50 may repeat the processes of steps S32 to S34, S40 to S42, and S47 for the next print job PJ. In this case, for one print job PJ, when the fabric feeding frequency acquired in step S47 is equal to or greater than the lower limit value (step S48: NO), printing can be completed to the end without replacing the fabric 33A midway.

### Effects of Second Embodiment

Accordingly, according to the second embodiment, the following effects are also obtained in addition to the effects (1-1) to (1-10) in the first embodiment.

(2-1) When the control unit 50 receives the start signal for the plurality of print jobs PJ, the control unit 50 acquires the available amount and the predicted usage amount for the plurality of print jobs PJ. An extension operation of changing the reference feed amount per unit to the feed amount smaller than the reference feed amount per unit and executing the plurality of print jobs PJ when the available amount is smaller than the predicted usage amount is performed. With this configuration, even when the plurality of print jobs PJ are submitted in succession, it is possible to curb concern that printing is interrupted due to runout of the available accommodation member 33 during printing. In other words, the printing based on the plurality of print jobs PJ can all be completed without interruption.

### Third Embodiment

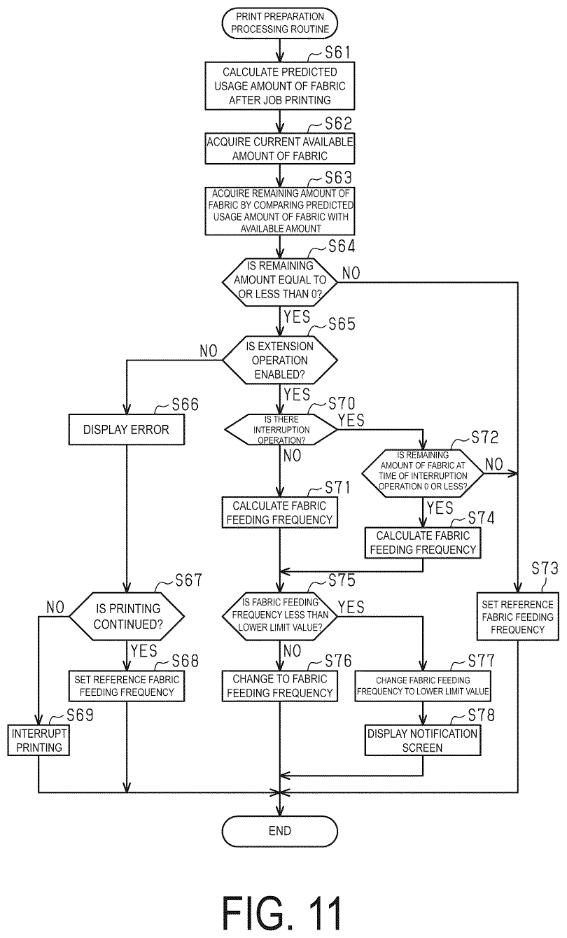

Next, a printing apparatus 11 of a third embodiment will be described with reference to FIG. 11. In the third embodiment, the content of the print preparation processing routine differs from that of the first and second embodiments. In each of the above embodiments, an interruption operation other than replacement of the accommodation member 33 (fabric replacement) is not taken into consideration when the fabric feeding frequency is determined. On the other hand, in the third embodiment, the feed amount per unit of the accommodation member 33 (for example, fabric feeding frequency) is set in consideration of other interruption operations. That is, when the control unit 50 receives the start signal for the print job PJ, the control unit 50 determines whether or not there is an interruption operation of interrupting the print job PJ during execution of the print job PJ. When the available amount of the accommodation member 33 is smaller than the predicted usage amount and there is an interruption operation, the reference feed amount per unit is changed to the feed amount per unit and the print job PJ is executed. The feed amount per unit is calculated so that the available amount of the accommodation member 33 until the execution of the print job PJ is interrupted by the interruption operation becomes the replacement setting value C at which replacement of the accommodation member 33 is to be prompted. Other configurations other than the print preparation process are the same as those in the first embodiment. Hereinafter, the print preparation process of the third embodiment will be described. As in the first embodiment, the accommodation member 33 is an example of the fabric 33A. Further, the reference feed amount per unit is an example of the reference fabric feeding frequency (an example of the reference frequency), and the feed amount per unit of the accommodation member 33 is an example of the fabric feeding frequency (an example of the change frequency), as in the first embodiment. Further, an example in which the replacement setting value C is 0 (zero) will be described.

When the control unit 50 receives the start signal for the print job PJ, the control unit 50 executes a print preparation processing routine shown in a flowchart in FIG. 11. Specifically, the computer 50C constituting the control unit 50 executes the print preparation processing routine.

The control unit 50 executes respective processes from step S61 to step S65 in order. Here, the respective processes from step S61 to step S65 are the same as respective processes from step S11 to step S14 and step S16 in the first embodiment. First, the control unit 50 calculates the predicted usage amount of the fabric 33A after printing based on one print job PJ for which the start signal has been received (step S61). Next, the control unit 50 acquires a current available amount of fabric (step S62). Next, the control unit 50 compares the predicted usage amount with the available amount of fabric 33A to acquire the remaining amount of fabric (step S63). For example, the control unit 50 acquires the remaining amount of fabric from a calculation result of subtracting the predicted usage amount from the available amount of fabric 33A. Further, the control unit 50 determines whether the remaining amount of fabric is 0 or less. When the remaining amount of fabric is 0 or less, the control unit 50 proceeds to step S65, and when the remaining amount of fabric is not 0 or less, the control unit 50 proceeds to step S73. In step S65, the control unit 50 determines whether or not the extension operation is enabled. When the extension operation is not enabled (that is, is enabled), the control unit 50 proceeds to step S66 and executes the processes of steps S66 to S69. The processes of steps S66 to S69 are the same as the processes of steps S17 to S20 in the first embodiment. In the third embodiment, the processes of steps S70 to S78 differ from the above-described embodiments.

In step S70, the control unit 50 determines whether the interruption operation has been performed. In other words, when the control unit 50 executes the print job PJ, the control unit 50 determines whether or not there is an interruption operation of interrupting the printing before the executed print job PJ has been completed. Here, the interruption operation is an operation of interrupting the printing other than the replacement of the fabric 33A (the accommodation member 33). Examples of the interruption operation may include a cleaning operation and base material replacement. The control unit 50 executes the cleaning operation according to a printing history. The printing history is a printing length, a printing time, the number of printed sheets, or the like. For example, when the printing history is the printing length, one cleaning operation is executed for every predetermined printing length such as 100 m or 200 m. When the printing history is the printing time, one cleaning operation is executed for every predetermined printing time such as 1 hour or 2 hours. Further, the base material is the medium 99 or the liquid supply source. The liquid supply source is, for example, an ink cartridge. In other words, the base material replacement is replacement of the medium 99 or replacement of the liquid supply source. When a supply form of the medium 99 is the roll body 100, replacement of the medium 99 is roll body replacement in which the user sets a new roll body 100 in the medium feeding unit 13. Further, the replacement of the liquid supply source is a cartridge replacement in which the user replaces the ink cartridge with a new one when the liquid such as ink in the ink cartridge reaches an amount of end. Thus, examples of the interruption operation may include a cleaning operation performed by the control unit 50, a roll body replacement operation by the user, and a cartridge replacement operation by the user.

The control unit 50 manages an implementation timing of a next cleaning operation based on a print history. The control unit 50 determines whether a cleaning operation is necessary during the execution of the current print job PJ based on the print history information from the end of the previous cleaning and the predicted print history information based on the current print job PJ. The control unit 50 also manages the remaining amount of the roll body 100 on the medium feeding unit 13 side. The control unit 50 stops the printing when the remaining amount of the roll body 100 on the medium feeding unit 13 side reaches an end value and prompts the user to replace the roll body. In detail, the control unit 50 acquires the current remaining amount of the roll body 100 on the medium feeding unit 13 side. The control unit 50 acquires the predicted printing length based on the image data and the number of times of printing included in the current print job PJ. The control unit 50 determines whether or not a roll replacement operation is required during the execution of the current print job PJ based on the acquired current remaining amount of the roll body 100 and the predicted printing length. Further, the control unit 50 manages the remaining amount of ink in the ink cartridge. When the remaining amount of liquid in the ink cartridge reaches an end value, the control unit 50 stops the printing and prompts the user to replace the cartridge. In detail, the control unit 50 acquires a current remaining amount of the ink cartridge. The control unit 50 acquires a predicted liquid consumption amount based on the image data and the number of times of printing included in the current print job PJ. The control unit 50 determines whether or not the cartridge replacement operation is required during the execution of the current print job PJ based on the current remaining amount of the ink cartridge and the predicted liquid consumption amount.

When the control unit 50 predicts that at least one of the interruption operations designated in advance is required during the execution of the current print job PJ, the control unit 50 determines that there is an interruption operation. When the control unit 50 determines that there is no interruption operation (step S70: NO), the process proceeds to step S71. On the other hand, when the control unit 50 determines that there is an interruption operation (step S70: YES), the process proceeds to step S72. The at least one interruption operation designated in advance may be only one of the cleaning operation, the roll body replacement (medium replacement), and the cartridge replacement, may be two, or may be all of three. Also, there may be other interruption operations designated other than the three.

In step S71, the control unit 50 calculates the fabric feeding frequency. That is, the control unit 50 calculates the fabric feeding frequency at which the remaining amount of fabric reaches the replacement setting value C (for example, 0) when the printing based on the print job PJ has all been completed. In other words, the control unit 50 calculates the feed amount per unit such that the available amount (remaining amount of fabric) of the accommodation member 33 (fabric 33A) exactly reaches the replacement setting value C when the printing based on the print job PJ has all been completed. Since this is an example in which the fabric 33A is fed intermittently, the fabric feeding frequency at which the fabric 33A is fed once per unit by a predetermined feed amount is calculated as the feed amount per unit of the fabric 33A.

In step S72, the control unit 50 determines whether the remaining amount of fabric at the time of the interruption operation is 0 or less. That is, the control unit 50 calculates the predicted usage amount of the fabric 33A (the predicted usage amount of the accommodation member 33) at a time when printing is interrupted due to the interruption operation during the execution of the print job PJ. The control unit 50 compares this predicted usage amount of the fabric 33A with the available amount (step S62) to acquire the remaining amount of fabric at the time of interruption of printing due to the interruption operation. For example, the control unit 50 acquires the remaining amount of fabric at the time of interruption of printing due to the interruption operation from a calculation result of subtracting the predicted usage amount from the available amount of the fabric 33A. The control unit 50 determines whether or not this remaining amount of fabric at the time of the interruption operation is equal to or less than 0, which is an example of the replacement setting value C. When the remaining amount of fabric at the time of the interruption operation is not equal to or less than 0, the control unit 50 proceeds to step S73. On the other hand, when the remaining amount of fabric at the time of the interruption operation is equal to or less than 0, the control unit 50 proceeds to step S74. The replacement setting value C is 0 (zero) in this example, but the replacement setting value C may be a value greater than 0.

In step S73, the control unit 50 sets the reference fabric feeding frequency. This process is the same as the process of step S15 in the first embodiment. That is, the control unit 50 sets a default reference fabric feeding frequency. When there is no shortage of unused accommodation members 33 until execution of the print job PJ is interrupted due to the interruption operation, the feed amount per unit of the accommodation member 33 is set to the reference feed amount. In this example in which the accommodation member 33 is fed intermittently, the control unit 50 sets the accommodation member 33 to be fed at the reference feeding frequency. In an example in which the accommodation member 33 is fabric, the control unit 50 sets the reference fabric feeding frequency.

In step S74, the control unit 50 calculates the fabric feeding frequency. That is, the control unit 50 calculates the fabric feeding frequency such that the remaining amount of fabric when execution of the print job PJ is interrupted due to the interruption operation is the replacement setting value C (for example, 0). In other words, the control unit 50 calculates the feed amount per unit of the accommodation member 33 so that the remaining amount of the accommodation member 33 exactly reaches the replacement setting value C at a time when the execution of the print job PJ is interrupted due to the interruption operation. In an example in which the accommodation member 33 is intermittently fed, the control unit 50 calculates the fabric feeding frequency as the feed amount per unit of the accommodation member 33. The fabric feeding frequency is a frequency at which the fabric 33A, which is an example of the accommodation member 33, is fed once by a predetermined feed amount per unit.

In step S75, the control unit 50 determines whether the fabric feeding frequency is less than the lower limit value. This process is the same as the process of step S22 in the first embodiment. When the fabric feeding frequency is not less than the lower limit value (step S75: NO), the control unit 50 proceeds to step S76. On the other hand, when the fabric feeding frequency is less than the lower limit value (step S75: YES), the control unit 50 proceeds to step S77.

In step S76, the control unit 50 changes the fabric feeding frequency to the calculated one. This process is the same as the process of step S23 in the first embodiment. However, in the third embodiment, the fabric feeding frequency when there is an interruption operation is a value at which the remaining amount of fabric 33A is exactly the replacement setting value C at a time when the execution of the print job PJ is interrupted due to the interruption operation. The control unit 50 changes the fabric feeding frequency from a default reference fabric feeding frequency, which is an example of the reference frequency, to the fabric feeding frequency, which is an example of the change frequency.

In step S77, the control unit 50 changes the fabric feeding frequency to a lower limit value. This process is the same as the process of step S24 in the first embodiment.

In the next step S78, the control unit 50 displays the notification screen SC3. This process is the same as the process of step S25 in the first embodiment. The control unit 50 causes the display unit 61 (91) to display the notification screen SC3 illustrated in FIG. 7. On the notification screen SC3, the user confirms the message M3 indicating that the accommodation member 33 (for example, fabric) will be replaced during printing, and then selects the OK button 83 by operating the selection unit 62. The control unit 50 may confirm the setting of the lower limit value when an operation signal indicating that the OK button 83 is operated on the notification screen SC3 is input.

Thus, when the control unit 50 ends the print preparation process, the control unit 50 executes the print job PJ. Before, during, and after this printing, the control unit 50 performs a feeding operation of feeding the fabric 33A at the fabric feeding frequency set in the print preparation process. In the third embodiment, when the extension operation is enabled and there is an interruption operation, the fabric 33A is intermittently fed at the fabric feeding frequency such that the remaining amount of the accommodation member 33 when the execution of the print job PJ is interrupted due to the interruption operation exactly reaches the replacement setting value C.

When the print job PJ that is being executed is interrupted due to the interruption operation, the remaining amount of the fabric 33A at this time reaches the replacement setting value C. For example, when the interruption operation is a cleaning operation, the control unit 50 performs the cleaning operation after the printing is interrupted and also displays an error screen SC4 (FIG. 8) on the display unit 61 (91) to prompt the user to replace the accommodation member 33. When the interruption operation is a cartridge replacement or roll body replacement, the control unit 50 displays information for prompting the user to perform the interruption operation and an error screen SC4 on the display unit 61 (91) after the printing is interrupted.

The user can replace the accommodation member 33 by using a timing when the print job PJ that is being executed is interrupted due to the interruption operation. This makes it possible to avoid the print job PJ that is being executed being interrupted twice due to separate causes including the interruption operation and the replacement of the accommodation member 33. This reduces the frequency of interruptions of the print job PJ, improving the production efficiency of printed matter. Further, a frequency at which the accommodation member 33 can be used up increases.

### Effects of Third Embodiment

Accordingly, according to the third embodiment, the effects (1-2) to (1-10) in the first embodiment can be obtained similarly, and the following effects can also be obtained.

(3-1) When the control unit 50 receives the start signal for the print job PJ, the control unit 50 determines whether or not there is an interruption operation of interrupting the print job PJ during execution of the print job PJ. When the available amount of the accommodation member 33 is smaller than the predicted usage amount and there is an interruption operation, the control unit 50 changes the reference feed amount per unit to the feed amount per unit and executes the print job PJ. The feed amount per unit is calculated so that the available amount until the execution of the print job PJ is interrupted by the interruption operation becomes the replacement setting value C at which replacement of the accommodation member 33 is to be prompted. With this configuration, when printing is interrupted by the interruption operation, the accommodation member 33 can be used up at a timing thereof, making it possible to effectively use time.

The above embodiments can also be modified into forms such as the following modification examples. Further, a further modification example may be made by appropriately combining the above embodiments and modification examples to be illustrated hereinafter, or a further modification example may be made by appropriately combining the modification examples to be illustrated hereinafter.
The setting of whether to enable the extension operation is not limited to the selection by the user using the selection unit 62. The control unit 50 may determine whether to enable the extension operation, and may set the extension operation to enabled when the control unit 50 determines that the extension operation is to be enabled. Also, the control unit 50 may be configured to always compare the available amount of the accommodation member 33 with the predicted usage amount, and perform the extension operation always when the available amount is smaller than the predicted usage amount.
In each embodiment, a cleaning operation of discharging a liquid from the nozzle 24 of the liquid ejection unit 23 to the accommodation member 33 of the liquid accommodation unit 32 may be performed. In this case, the predicted usage amount of the accommodation member 33 predicted to be used in flushing in the print job PJ may include the predicted usage amount of the accommodation member 33 associated with the cleaning operation (predicted cleaning usage amount). For example, the control unit 50 determines whether there is a cleaning operation during the completion of the printing based on the print job PJ. When there is the cleaning operation, the control unit 50 may calculate the predicted usage amount of the accommodation member 33 by adding the predicted usage amount of the accommodation member 33 predicted to be used in flushing in the print job PJ when the accommodation member 33 is sent at the reference feed amount per unit, to the predicted usage amount of the accommodation member 33 associated with the cleaning operation. The available amount of the accommodation member 33 that can be used for flushing is not limited to an available amount that can be used only for flushing, and may include an available amount that can be used for the cleaning operation. Further, on the other hand, the predicted usage amount of the accommodation member 33 predicted to be used for flushing regardless of the presence or absence of the cleaning operation may be a value predicted to be used only for flushing. In this case, the available amount of the accommodation member 33 may be the available amount that can be used only for flushing, excluding the available amount predicted to be used in the cleaning operation from the total available amount of the accommodation member 33 at the point in time when the print job starts.
In the second embodiment, a process related to the interruption operation in the third embodiment (for example, steps S70 to S72 and S74) may be added. In other words, the process of the second embodiment and the process of the third embodiment may be combined.
In the third embodiment, in the printing apparatus 11 that uses an ink tank as a liquid supply source, the interruption operation may be an ink refill operation that refills the ink tank with ink. In other words, the interruption operation may be replacing/replenishing the liquid supply source.
In the third embodiment, in the printing apparatus 11 including a cassette as a medium supply unit, the interruption operation may be a medium refill operation in which the user refills the cassette with the medium 99 when the medium 99 runs out in the cassette.
When the base material reaches the replacement timing, the control unit 50 notifies of information for prompting base material replacement. When the base material is a medium 99 such as paper, the control unit 50 performs a notification for prompting the medium 99 to be refilled or replaced. When the base material is a liquid cartridge such as an ink cartridge, the control unit 50 performs a notification for prompting the liquid cartridge to be replaced.
In the third embodiment, when the wiping member 38 of the wiping unit 37 is a fabric wiper that is fabric, the interruption operation may be a replacement operation for the wiping member 38 that is prompted to the user when the remaining amount of the wiping member 38 reaches the replacement setting value C. The replacement of the wiping member 38 may be performed by replacing the roll body of the wiping member 38, or replacing the wiping unit 37 as a unit.
In the third embodiment, when the printing apparatus 11 includes a replaceable waste liquid accommodation unit (for example, a waste liquid recovery tank), the interruption operation may be replacement of the waste liquid accommodation unit.
In the third embodiment, when the printing apparatus 11 is an apparatus in which printing is interrupted for a flushing operation, the interruption operation may be a flushing operation.
In the third embodiment, when the printing apparatus 11 is an apparatus in which printing is interrupted for a wiping operation, the interruption operation may be a wiping operation of wiping the nozzle surface 25 of the liquid ejection unit 23.
In the third embodiment, the cleaning operation as the interruption operation may be performed when a time counted from a point in time when the previous cleaning operation has ended reaches a threshold, or may be performed when the printing length or number of printed sheets from a point in time when the previous cleaning has ended reaches a threshold.
The nozzle inspection unit that inspects whether the cleaning operation is necessary may be, for example, the following one. The nozzle inspection unit may be a unit that drives a drive element (for example, a piezoelectric element 26) that operates to eject ink from the nozzle 24 to the extent that ink is not ejected from the nozzle 24, and inspects the presence or absence of a defective nozzle based on a residual vibration acting on the ink in a cavity (ink chamber) that communicates with the nozzle 24. In this case, the nozzle inspection unit detects the presence or absence of foreign matter or air bubbles mixed in the ink in the nozzle 24, the presence or absence of thickened ink in the nozzle 24, and the presence or absence of foreign matter such as paper powder adhering around an opening of the nozzle 24.
The liquid ejection unit 23 may include the nozzle 24 that ejects pigment ink, and the nozzle 24 that ejects dye ink. In this case, a plurality of liquid accommodation units 32 that separately accommodate flushing from the nozzles 24 that eject the dye ink and flushing from the nozzles 24 that eject the dye ink may be included. In this case, the feed amount per unit of the accommodation member 33 may differ depending on a type of ink that the accommodation member 33 accommodates. In this case, a replacement process of one of the two liquid accommodation units 32 may be an interruption process, and the feed amount per unit during the other extension operation may be determined.
When the accommodation member 33 is a fabric, the accommodation member 33 may be a nonwoven fabric, woven fabric, knitted fabric, or the like.
The accommodation member 33 is not limited to the fabric. The accommodation member 33 may be, for example, paper or cellulose. For example, the accommodation member 33 may be roll paper for flushing. The accommodation member 33 may also be a sponge sheet. In short, the accommodation member 33 may be made of a material that can absorb at least a portion of the liquid, such as ink, ejected by flushing from the nozzles of the liquid ejection unit 23.
The liquid accommodation unit 32 is not limited to a type in which the winding unit 36 actively winds and the feeding unit 35 follows the winding unit 36. For example, the liquid accommodation unit 32 may be a type in which the feeding unit 35 actively unwinds and the winding unit 36 follows the feeding unit 35. In this case, the winding unit 36 may be biased by a biasing means such as a spiral spring to rotate in the winding direction. Further, the feeding unit 35 and the winding unit 36 may both be configured to actively operate. In other words, the feeding unit 35 and the winding unit 36 may each be driven by a driving force of the motor 75M as a driving source. In this case, the motor 75M may be provided separately for the feeding unit 35 and the winding unit 36, or may be a single motor in common to the feeding unit 35 and the winding unit 36.
The liquid accommodation unit 32 is not limited to a configuration that performs the intermittent feeding operation of sending the accommodation member 33 intermittently, and may be configured to send the accommodation member 33 at a constant speed. In short, the accommodation member 33 may be sent at a predetermined feed amount per unit. A time when the feed amount per unit is the reference feed amount may be set as a default (reference), and the reference feed amount in the extension operation may be changed to a feed amount smaller than the reference feed amount. In other words, the reference feed amount per unit may be changed to a feed amount per unit smaller than the reference feed amount in the extension operation. The “unit” per unit may be any of the printing length, the printing time, and the printing amount. The printing amount may be an amount of ink ejected from the nozzle 24 for printing. The amount of ink may be specified based on a pixel value of the image data in the print job PJ, or may be specified by measuring the amount of ink ejected from the nozzle 24 by the liquid ejection unit 23. Further, the printing length is not limited to the printing length when the medium 99 is in a roll shape, but may include the number of printed sheets when the medium 99 is a sheet of paper such as a cut sheet. In other words, the unit may be the number of printed sheets of the medium 99. Further, the printing length may or may not include a length of a margin of the medium 99. Further, the printing time may or may not include a time to transport a portion of the margin of the medium 99. Further, the printing time may or may not include a time for flushing (empty ejection) or wiping during printing. Thus, the feed amount per unit may be the feed amount per unit printing length, may be the feed amount per unit number of printed sheets, may be the feed amount for each unit printing time, or may be the feed amount per unit printing amount. As long as the accommodation member 33 is fed at a predetermined feed amount per unit, the operation of feeding the accommodation member 33 may be an intermittent feeding operation of feeding the accommodation member 33 intermittently, or may be a constant speed feeding operation of feeding the accommodation member 33 continuously at a constant speed. Further, the operation of feeding the accommodation member 33 may be a variable speed feeding operation in which the speed is changed instead of a constant speed feeding operation. Further, the unit may be a unit related to printing other than the printing length, the printing time, the printing amount, or the like, or may be a unit other than the unit related to the printing. In the latter case, the unit may simply be time, or may be a medium transport length or the like.
The printing apparatus 11 may be of a lateral type described in the embodiment, or may be of a serial type. Further, the printing apparatus 11 may be of a line type in which the liquid ejection unit 23 has a shape that extends in a width direction of the medium 99. The line type of printing apparatus 11 (line printer) includes a line type of liquid ejection unit 23 having a long shape longer than a width dimension of the medium 99. Characters or images are printed on the medium 99 by ejecting liquid from the nozzles 24 of the line type of liquid ejection unit 23 to the entire width of the medium 99 all at once while transporting the medium 99 at a constant speed. In the line type of printing apparatus 11, the liquid ejection unit 23 and the liquid accommodation unit 32 are moved relative to each other, so that both are disposed in a flushing position state. After flushing is performed in this state, the liquid ejection unit 23 and the support portion 17 are moved relative to each other in a printing position state in which the liquid ejection unit 23 and the support portion 17 face each other, so that printing on the medium 99 is performed. For example, the liquid accommodation unit 32 may be configured to move to the flushing position FP at which the accommodation member 33 faces the nozzle surface 25 of the liquid ejection unit 23 across a predetermined gap.
The medium 99 is not limited to paper or the like, but may be an envelope, board paper, fabric, synthetic resin film, laminated medium, or the like.
In the above embodiment, the printing apparatus 11 may be a liquid ejection apparatus that ejects a liquid other than ink. A state of the liquid ejected from the liquid ejection apparatus as minute droplets includes granular, teardrop, and thread-like tails. Further, the liquid referred to here may be any material that can be ejected from the liquid ejection apparatus. For example, it is assumed that the liquid may be any matter in a state in which the matter is in a liquid phase, and includes a liquid body having high or low viscosity, and a fluid body such as sol, gel water, other inorganic solvents, an organic solvent, a solution, a liquid resin, and a liquid metal (metal molten liquid). Further, the matter may include one in which particles of a functional material made of a solid such as pigments or metal particles have been dissolved, dispersed, or mixed in a solvent, in addition to a liquid as one state of matter. Typical examples of the liquid include the ink and the liquid crystal as described in the above embodiment. The ink here includes various liquid compositions such as general aqueous ink and solvent ink, gel ink, and hot-melt ink. Specific examples of the liquid ejection apparatus 11 include a liquid ejection apparatus that ejects a liquid including a material such as an electrode material r a color material used, for example, in manufacture of a liquid crystal display, an electroluminescent (EL) display, a surface light emitting display, a color filter, or the like in a dispersed or dissolved form. Further, the liquid ejection apparatus may be a liquid ejection apparatus that ejects bioorganic substances used for biochip manufacturing, a liquid ejection apparatus used as a precision pipette and ejecting liquid to be a sample, a dye-printing apparatus, a micro dispenser, or the like. Further, the liquid ejection apparatus may be a liquid ejection apparatus that ejects a transparent resin liquid such as an ultraviolet cure resin onto a substrate in order to form a tiny hemispherical lens (optical lens), or the like used for an optical communication element or the like. When these liquid ejection apparatuses are configured to include the liquid accommodation unit 32 having the accommodation member 33 that accommodates the liquid ejected by flushing from the nozzle of the liquid ejection unit, it is possible to adopt an extension operation of adjusting the feed amount per unit of the accommodation member 33. Thus, in the printing apparatus 11 in this specification, the liquid ejected from the nozzle 24 of the liquid ejection unit 23 is not limited to ink, but may be various functional liquids. “Printing” in the printing apparatus 11 is defined as drawing (forming) characters, images, wiring patterns, pixel patterns, or the like on the medium 99 such as paper or a substrate using liquid such as ink or functional liquid ejected from the nozzle 24 of the liquid ejection unit 23. In this respect, the print job PJ is not limited to job data for instructing drawing on the medium 99 such as paper through ink ejection, but is a concept including job data for instructing drawing on the medium 99 such as a substrate through ejection of a functional liquid.

Hereinafter, technical spirits ascertained from the embodiments and the modification examples will be described together with the effects.
(A) A printing apparatus includes a liquid ejection unit configured to perform printing on a medium by ejecting a liquid, a liquid accommodation unit configured to accommodate the liquid ejected in flushing regardless of the printing by the liquid ejection unit, and a control unit, wherein the liquid accommodation unit includes an accommodation member configured to accommodate the liquid, a feeding unit having the accommodation member set therein, and a winding unit configured to wind up the accommodation member, and the control unit acquires an available amount of the accommodation member available for flushing and a predicted usage amount of the accommodation member predicted to be used in the flushing in the print job when the accommodation member is sent at a reference feed amount per unit when the control unit receives a start signal for a print job, and performs an extension operation of executing the print job by changing the reference feed amount per unit to a feed amount smaller than the reference feed amount per unit when the available amount is smaller than the predicted usage amount. With this configuration, it is possible to curb concern that printing is interrupted due to runout of the available accommodation member during printing by changing the feed amount per unit of the accommodation member according to the available amount.
(B) In the printing apparatus according to (A), the liquid accommodation unit may perform a feeding operation of feeding the accommodation member intermittently by a predetermined feed amount, the reference feed amount per unit may be a reference frequency that is a frequency at which the feeding operation of feeding the accommodation member at the reference feed amount per unit is performed once, and when the available amount is smaller than the predicted usage amount, the extension operation of executing the print job after changing the reference frequency to the feed amount smaller than the reference feed amount may be performed. With this configuration, it is possible to curb concern that an incomplete amount remains and printing is interrupted when the next print job is executed, by using up the accommodation member to the amount reaching the replacement timing.
(C) In the printing apparatus according to (A), the changed feed amount per unit may be calculated so that the available amount becomes a replacement setting value when replacement of the accommodation member is prompted, at a time when the print job is completed. With this configuration, it is possible to curb concern that an incomplete amount of accommodation member remains and printing is interrupted when the next print job is executed, by using up the accommodation member to the amount replacing the replacement timing.
(D) In the printing apparatus according to (B), the change frequency may be calculated so that the available amount becomes zero at a time when the print job is completed. The available amount being zero (0) is not limited to the available amount being exactly zero, and is defined as including an available amount in a range that can be recognized as zero in consideration of variations. With this configuration, it is possible to curb concern that an incomplete amount remains and printing is interrupted when the next print job is executed by using up the accommodation member completely.
(E) In the printing apparatus according to (B), the control unit may execute the print job by changing the reference feed amount to a lower limit value when the calculated feed amount per unit is equal to or less than the lower limit value. With this configuration, when the feed amount per unit of the accommodation member is reduced too much, there is concern that a liquid leaks from the accommodation member or a dried matter of the liquid or the like is deposited on the accommodation member, but this can be prevented.
(F) In the printing apparatus according to (E), the printing apparatus may include a display unit configured to display information, wherein the control unit may display on the display unit a message indicating that printing is interrupted when the reference feed amount is changed to the lower limit value. With this configuration, the user can be aware of the interruption of the printing in advance, thereby improving usability for the user. For example, the user can be aware of the interruption of the printing due to the replacement of the accommodation member during the printing in advance.
(G) In the printing apparatus according to (A), the extension operation may be executed when the extension operation is enabled. With this configuration, the extension operation is executed only when the extension operation is enabled so that productivity can be improved compared to when the extension operation is disabled.
(H) In the printing apparatus according to (G), the printing apparatus may include a selection unit configured to select whether to execute the extension operation, and the control unit may enable the extension operation when execution of the extension operation is selected in the selection unit. With this configuration, the execution of the extension operation can be selected by the selection unit, thereby improving usability for the user.
(I) In the printing apparatus according to (A), the control unit may determine whether or not there is an interruption operation of interrupting the print job during execution of the print job when receiving the start signal for the print job, and when the available amount is smaller than the predicted usage amount and there is an interruption operation, the reference feed amount per unit may be changed to the feed amount per unit calculated so that the available amount until the execution of the print job is interrupted by the interruption operation becomes a replacement setting value at which replacement of the accommodation member is to be prompted, and the print job may be executed. With this configuration, when printing is interrupted by the interruption operation, the accommodation member can be used up at a timing thereof, making it possible to effectively use time.
(J) In the printing apparatus according to any one of (A) to (I), the control unit may acquire the available amount and the predicted usage amount in a plurality of print jobs when receiving a start signal for the plurality of print jobs, and when the available amount is smaller than the predicted usage amount, the extension operation of changing the reference feed amount per unit to the feed amount smaller than the reference feed amount and executing the plurality of print jobs may be performed. With this configuration, even when the plurality of print jobs PJ are submitted in succession, it is possible to curb concern that printing is interrupted due to runout of the available accommodation member during printing.
(K) A control method for a printing apparatus includes a liquid ejection unit configured to perform printing on a medium by ejecting a liquid, and a liquid accommodation unit configured to accommodate the liquid ejected in flushing regardless of the printing by the liquid ejection unit, the liquid accommodation unit including an accommodation member configured to accommodate the liquid, a feeding unit having the accommodation member set therein, and a winding unit configured to wind up the accommodation member, the control method including acquiring an available amount of the accommodation member used for flushing and a predicted usage amount of the accommodation member predicted to be used in the flushing in the print job when the accommodation member is sent at a reference feed amount per unit when a start signal for a print job is received, and performing an extension operation of executing the print job by changing the reference feed amount per unit to a feed amount smaller than the reference feed amount per unit when the available amount is smaller than the predicted usage amount. With this method, it is possible to curb concern that printing is interrupted due to runout of the available accommodation member during printing by changing the feed amount per unit of the accommodation member according to the available amount.
(L) In the control method for a printing apparatus according to (K), including calculating the changed feed amount per unit so that the available amount becomes a replacement setting value when replacement of the accommodation member is prompted, at a time when the print job is completed. With this method, it is possible to curb concern that an incomplete amount of accommodation member remains and printing is interrupted when the next print job is executed, by using up the accommodation member to the amount replacing the replacement timing.

What is claimed is:

1. A printing apparatus comprising:
a liquid ejection unit configured to perform printing on a medium by ejecting a liquid;
a liquid accommodation unit configured to accommodate the liquid ejected in flushing regardless of the printing by the liquid ejection unit; and
a control unit, wherein
the liquid accommodation unit includes:
an accommodation member configured to accommodate the liquid;
a feeding unit having the accommodation member set therein; and
a winding unit configured to wind up the accommodation member, and
the control unit
acquires an available amount of the accommodation member available for flushing and a predicted usage amount of the accommodation member predicted to be used in the flushing in the print job when the accommodation member is sent at a reference feed amount per unit when the control unit receives a start signal for a print job, and
performs an extension operation of executing the print job by changing the reference feed amount per unit to a feed amount smaller than the reference feed amount per unit when the available amount is smaller than the predicted usage amount.

2. The printing apparatus according to claim 1, wherein
the liquid accommodation unit performs a feeding operation of feeding the accommodation member intermittently by a predetermined feed amount,
the reference feed amount per unit is a reference frequency that is a frequency at which the feeding operation of feeding the accommodation member at the reference feed amount per unit is performed once, and when the available amount is smaller than the predicted usage amount, the extension operation of executing the print job after changing the reference frequency to a feed amount smaller than the reference feed amount is performed.

3. The printing apparatus according to claim 1, wherein
the changed feed amount per unit is calculated so that the available amount becomes a replacement setting value when replacement of the accommodation member is prompted, at a time when the print job is completed.

4. The printing apparatus according to claim 2, wherein
the change frequency is calculated so that the available amount becomes zero at a time when the print job is completed.

5. The printing apparatus according to claim 2, wherein
the control unit executes the print job by changing the reference feed amount to a lower limit value when the calculated feed amount per unit is equal to or less than the lower limit value.

6. The printing apparatus according to claim 5, comprising:
a display unit configured to display information, wherein
the control unit displays on the display unit a message indicating that printing is interrupted when the reference feed amount is changed to the lower limit value.

7. The printing apparatus according to claim 1, wherein
the extension operation is executed when the extension operation is enabled.

8. The printing apparatus according to claim 7, comprising:
a selection unit configured to select whether to execute the extension operation, wherein
the control unit enables the extension operation when execution of the extension operation is selected in the selection unit.

9. The printing apparatus according to claim 1, wherein
the control unit determines whether or not there is an interruption operation of interrupting the print job during execution of the print job when receiving the start signal for the print job, and
when the available amount is smaller than the predicted usage amount and there is an interruption operation, the reference feed amount per unit is changed to a feed amount per unit calculated so that the available amount until the execution of the print job is interrupted by the interruption operation reaches a replacement setting value at which replacement of the accommodation member is prompted, and the print job is executed.

10. The printing apparatus according to claim 1, wherein
the control unit acquires the available amount and the predicted usage amount in a plurality of print jobs when receiving a start signal for a plurality of print jobs, and
when the available amount is smaller than the predicted usage amount, the extension operation of changing the reference feed amount per unit to the feed amount smaller than the reference feed amount and executing the plurality of print jobs is performed.

11. A control method for a printing apparatus including a liquid ejection unit configured to perform printing on a medium by ejecting a liquid, and a liquid accommodation unit configured to accommodate the liquid ejected in flushing regardless of the printing by the liquid ejection unit, the liquid accommodation unit including an accommodation member configured to accommodate the liquid, a feeding unit having the accommodation member set therein, and a winding unit configured to wind up the accommodation member, the control method comprising:
acquiring an available amount of the accommodation member used for flushing and a predicted usage amount of the accommodation member predicted to be used in the flushing in the print job when the accommodation member is sent at a reference feed amount per unit when a start signal for a print job is received; and
performing an extension operation of executing the print job by changing the reference feed amount per unit to a feed amount smaller than the reference feed amount per unit when the available amount is smaller than the predicted usage amount.

12. The control method for a printing apparatus according to claim 11, comprising:
calculating the changed feed amount per unit so that the available amount becomes a replacement setting value when replacement of the accommodation member is prompted, at a time when the print job is completed.
